(19) United States
(12) Patent Application Publication
(10) Pub. No.: US 2009/0177346 A1
(43) Pub. Date: Jul. 9, 2009

(54) Dynamic estimation of vehicle inertial parameters and tire forces from tire sensors

(76) Inventor: Aleksander B. Hac, Dayton, OH (US)

Correspondence Address: DELPHI TECHNOLOGIES, INC., M/C 480-410-202, PO BOX 5052, TROY, MI, 48007, US

(21) Appl. No.: 12/004,007

(22) Filed: Dec. 19, 2007

(51) Int. Cl. B60W 30/02

(52) U.S. Cl. 701/29

(57) ABSTRACT

A method of estimating vehicle inertial parameters for use in a vehicle stability control system including the steps of obtaining measurements of tire normal forces, calculating an estimated total vehicle mass, calculating an estimated mass proportioned between axles, and performing a vehicle stability control calculation using an estimated vehicle inertial parameter. In a second aspect of the method, a method of estimating vehicle inertial parameters using measurements of tire lateral forces. In a third aspect, a method of predicting tire forces including the steps of obtaining measurements of tire normal or tire lateral forces, calculating a corresponding set of expected tire forces, blending the measured tire forces and said corresponding set of expected tire forces to produce a set of blended tire forces, calculating a second set of expected tire forces of the other kind, combining the set of blended tire forces and second set of expected tire forces to produce a set of predicted tire lateral forces for each tire of the vehicle, and performing a vehicle control calculation using the set of predicted tire lateral forces.

### TECHNICAL FIELD

The present disclosure relates to automotive control systems and, more particularly, to methods for dynamically estimating vehicle parameters such as mass, moment of inertia, center of mass location, and variables such as tire forces for use as inputs to a vehicle stability control system or other chassis control system.

### BACKGROUND

Existing vehicle stability control systems (“VSC systems”), including electronic stability control systems, electronic stability programs, vehicle dynamics control systems, dynamic stability control systems, and the like, typically combine measurements from accelerometers with pre-programmed nominal values of vehicle inertial properties to determine the forces that should be applied to a vehicle's wheels to maintain stability and control during driving scenarios such as avoidance maneuvers, losses of traction, oversteering, understeering, and the like. However, such systems are limited in that the mass and distribution of passengers and cargo will vary during real world use, causing a vehicle's actual inertial properties to differ from its nominal inertial properties when loading differs from the pre-programmed model. Such differences will decrease performance from that which might be obtained if actual inertial parameters, rather than pre-programmed nominal values, were incorporated into the model of vehicle dynamics employed in the vehicle's VSC system.

Intelligent tire sensors capable of providing information concerning tire pressure and tire wall deformation are known in the automotive arts. For example, U.S. Pat. No. 5,913,240 discloses a method and device capable of determining tire longitudinal force in a rotating tire by measuring the torsional deformation of the tire sidewall and the period of time that elapses between the passing of (at least) two markings arranged on the tire for that purpose. According to this patent, tire pressure and the size of the tire contact patch (tire footprint) can be determined using this method. By multiplying the area of the contact patch by the tire pressure, it is possible to calculate a tire normal force. Furthermore, U.S. Pat. No. 6,658,927 discloses a method capable of determining tire lateral force using the same device by measuring the amplitude of tire deformation in the lateral direction. U.S. Pat. Nos. 6,959,593 and 7,168,308 disclose a method capable of determining tire normal, lateral, and longitudinal forces using piezoelectric elements embedded in a tire. The measured and calculated variables are generated cyclically, once per revolution of the tire. Methods of determining tire forces have been disclosed in other patents, for example U.S. Pat. Nos. 5,877,679 and 6,952,954. The information obtained from such tire sensors is typically used to monitor tire performance, but might also be used to estimate “quasi-static” values of a vehicle's inertial properties for use in a VSC system.

The term “quasi-static” is used in recognition of the fact that vehicle inertial properties such as total vehicle mass will tend to vary as passenger and cargo loadings change, but remain essentially constant during a particular instance of use. The term “quasi-static” is also used in recognition of the fact that estimated parameter values will necessarily approximate the actual properties, being subject to measurement noise and various systematic errors depending upon the methods used to analyze the properties. Quasi-static estimated parameters may be employed in combination with or in place of pre-programmed nominal values of vehicle inertial properties, and improve VSC system performance by enabling the system to account for a vehicle's actual inertial properties. Such parameters may also be further employed, in conjunction with available sensor data, to produce estimates of tire lateral and normal forces at high sampling rates for the improvement of VSC systems, active steering systems, controlled suspension systems, and the like.

### SUMMARY

In a first aspect, a method of estimating vehicle inertial parameters for use in a vehicle stability control system, the method including the steps of obtaining measurements of tire normal forces; calculating an estimated total vehicle mass; calculating an estimated mass proportioned between axles, e.g., an estimated front mass and an estimated rear mass; and performing a vehicle stability control calculation using an estimated vehicle inertial parameter selected from a group consisting of estimated total vehicle mass, estimated mass proportioned between axles, estimated front mass, and estimated rear mass. The method may further include calculating an estimated vehicle yaw moment of inertia, calculating an estimated height of the vehicle center of mass, calculating an estimated vehicle static stability factor, and performing a vehicle stability control calculation using the additional calculated value(s).

In a second aspect of the method, the method includes the steps of obtaining measurements of tire lateral forces, vehicle lateral acceleration, and vehicle yaw rate; calculating an estimated mass proportioned between axles, e.g., an estimated front mass and an estimated rear mass; and performing a vehicle stability control calculation using an estimated vehicle inertial parameter selected from a group consisting of estimated mass proportioned between axles, estimated front mass, and estimated rear mass, or a vehicle parameter incorporating at least one of the same. The method may further include calculating an estimated vehicle yaw moment of inertia and performing a vehicle stability control calculation using the additional calculated value.

In a third aspect, a method of predicting tire forces for use in a vehicle stability control system, the method including the steps of obtaining measurements of tire forces from one of group consisting of tire normal forces and tire lateral forces; calculating a corresponding set of expected tire forces using an estimated vehicle inertial parameter and a measurement of acceleration; blending the measured tire forces and said corresponding set of expected tire forces to produce a set of blended tire forces; calculating a second set of expected tire forces of the other kind using an estimated vehicle mass parameter and a measurement of acceleration; combining the set of blended tire forces and the second set of expected tire forces to produce a set of predicted tire lateral forces for each tire of the vehicle; and performing a vehicle control calculation using the set of predicted tire lateral forces.

### BRIEF DESCRIPTION OF THE DRAWINGS

FIG. 1 is a flow chart showing the steps of a method for estimating vehicle inertial parameters using measurements of tire normal forces.

FIGS. 2A-2D are graphs of vehicle sensor data collected during simulated travel through two oppositely-directed slow-rate turning maneuvers.

FIG. 3 is a graph of an estimated total vehicle mass calculated according to a preferred implementation of a method using measurements of tire normal forces over the travel scenario illustrated in FIGS. 2A-2D.

FIGS. 4-6 are graphs of estimated front mass, vehicle yaw moment of inertia, and height of the vehicle center of mass calculated under conditions corresponding to those used to produce FIGS. 2A-2D and 3.

FIGS. 7A-7D are graphs of vehicle sensor data collected during simulated travel through a ‘step steer’ maneuver.

FIG. 8 is a graph of an estimated total vehicle mass calculated according to a preferred implementation of a method using measurements of tire normal forces over the travel scenario illustrated in FIGS. 7A-7D.

FIGS. 9-11 are graphs of estimated front mass, vehicle yaw moment of inertia, and height of the vehicle center of mass calculated under conditions corresponding to those used to produce FIGS. 7A-7D and 8.

FIGS. 12A-12D are graphs of vehicle sensor data collected during simulated travel through a ‘ramp steer’ maneuver.

FIG. 13 is a graph of an estimated total vehicle mass calculated according to a preferred implementation of a method using measurements of tire normal forces over the travel scenario illustrated in FIGS. 12A-12D.

FIGS. 14-16 are graphs of estimated front mass, vehicle yaw moment of inertia, and height of the vehicle center of mass calculated under conditions corresponding to those used to produce FIGS. 12A-12D and 13.

FIG. 17 illustrates an exemplary model of vehicle dynamics for use in the method for estimating vehicle inertial parameters using measurements of tire lateral forces.

FIG. 18 is a flow chart showing the steps of a method for estimating vehicle inertial parameters using measurements of tire lateral forces.

FIGS. 19-22 are graphs of estimated front mass, estimated rear mass, total vehicle mass, and vehicle yaw moment of inertia calculated according to a preferred implementation of a method using measurements of tire lateral forces over the travel scenario illustrated in FIGS. 2A-2D.

FIGS. 23-26 are graphs of estimated front mass, estimated rear mass, total vehicle mass, and vehicle yaw moment of inertia calculated according to a preferred implementation of a method using measurements of tire lateral forces over the travel scenario illustrated in FIGS. 7A-7D.

FIGS. 27-30 are graphs of estimated front mass, estimated rear mass, total vehicle mass, and vehicle yaw moment of inertia calculated according to a preferred implementation of a method using measurements of tire lateral forces over the travel scenario illustrated in FIGS. 12A-12D.

FIG. 31 is a flow chart showing the steps of a method for predicting tire forces at high sampling rates using measurements of tire forces at low sampling rates and estimated vehicle inertial parameters.

FIGS. 32A and 32B are graphs of tire lateral forces, including expected tire lateral forces calculated according to equations (28a) and (28b), over the travel scenario illustrated in FIGS. 2A-2D when using the nominal values of inertial parameters.

FIGS. 33A and 33B are graphs of tire lateral forces, including predicted tire lateral forces calculated according to a method for predicting tire forces, over the travel scenario illustrated in FIGS. 2A-2D. The applied method uses, in part, the estimated vehicle inertial parameters plotted in FIGS. 3-6.

FIGS. 34A and 34B are graphs of tire lateral forces, including predicted tire lateral forces calculated according to a method for predicting tire forces, over the travel scenario illustrated in FIGS. 2A-2D. The applied method uses, in part, the estimated vehicle inertial parameters plotted in FIGS. 19-22.

FIGS. 35A and 35B are graphs of tire lateral forces, including expected tire lateral forces calculated according to equations (28a) and (28b), over the travel scenario illustrated in FIGS. 7A-7D when using the nominal values of inertial parameters.

FIGS. 36A and 36B are graphs of tire lateral forces, including predicted tire lateral forces calculated according to a method for predicting tire forces, over the travel scenario illustrated in FIGS. 7A-7D. The applied method uses, in part, the estimated vehicle inertial parameters plotted in FIGS. 8-11.

FIGS. 37A and 37B are graphs of tire lateral forces, including predicted tire lateral forces calculated according to a method for predicting tire forces, over the travel scenario illustrated in FIGS. 7A-7D. The applied method uses, in part, the estimated vehicle inertial parameters plotted in FIGS. 23-26.

FIGS. 38A and 38B are graphs of tire lateral forces, including expected tire lateral forces calculated according to equations (28a) and (28b), over the travel scenario illustrated in FIGS. 12A-12D when using the nominal values of inertial parameters.

FIGS. 39A and 39B are graphs of tire lateral forces, including predicted tire lateral forces calculated according to a method for predicting tire forces, over the travel scenario illustrated in FIGS. 12A-12D. The applied method uses, in part, the estimated vehicle inertial parameters plotted in FIGS. 13-16.

FIGS. 40A and 40B are graphs of tire lateral forces, including predicted tire lateral forces calculated according to a method for predicting tire forces, over the travel scenario illustrated in FIGS. 12A-12D. The applied method uses, in part, the estimated vehicle inertial parameters plotted in FIGS. 27-30.

### DETAILED DESCRIPTION

### Definitions

For the purposes of this application, descriptions of calculations involving masses such as total vehicle mass will be understood to also describe and pertain to calculations involving weights, with the appropriate variables being properly interconverted and incorporated into the calculations as needed. Accordingly, claim limitations reciting a “mass” element, e.g., “calculating an estimate of total vehicle mass,” shall be construed to include measurements or calculations involving a corresponding weight, e.g., calculating an estimate of static vehicle weight. Additionally, descriptions of measurements, calculated values, and observations should be understood to be referring to simple values based either explicitly or indirectly upon a single observation of a pertinent sensor, sensor group, or combination of sensors, whereas descriptions of calculated estimates or estimated values should be understood to be referring to time-averaged values based either explicitly or implicitly upon a plurality of observations of the pertinent sensor, sensor group, or combination of sensors collected over time. Accordingly, claim limitations reciting an “estimate” or an “estimated” element, e.g., “calculating an estimate of total vehicle mass,” shall be construed as being limited to the calculation of a time-averaged value of the recited property, or the value of a recited property that is calculated based upon such a time-averaged value. Additionally, predicted values should be understood as to be referring to values of variables being functions of time, which are calculated at any time instant on the basis of information available up to that time instant.

### Estimation of Vehicle Inertial Parameters Using Tire Normal Forces

If a vehicle such as a passenger car travels over a flat surface at approximately constant speed, then measurements of tire normal forces may be used to calculate quasi-static estimates of vehicle inertial properties such as total vehicle mass, mass proportioned between axles, and vehicle yaw moment of inertia. If such a vehicle performs a smooth turning maneuver, then such measurements may optionally be combined with measurements of lateral acceleration to calculate quasi-static estimates of vehicle inertial properties such as the height of the vehicle center of mass and the vehicle static stability factor. The fundamental relationships which form the basis of the estimation algorithm are explained below.

Measurements of tire normal forces may be combined to calculate a near-instantaneous value of a vehicle inertial parameter by employing a force balance such as the one shown in equation (1), where N_{fl}, N_{fr}, Nᵣₗ, and Nᵣᵣ denote measurements of the tire normal forces at the front left, front right, rear left, and rear right tires of a four-wheeled vehicle, g is the acceleration of gravity, and m_{T} is the total vehicle mass.

N_{fl}+N_{fr}+Nᵣₗ+Nᵣᵣ=m_{T}g (1)

Equation (1) is a highly simplified and exemplary force balance. Those skilled in the art will recognize that equation (1) fails to account for non-gravitational contributions to tire normal forces, and therefore may yield erroneous results when a vehicle travels at high speeds, accelerates/decelerates at a substantial rate, or reacts to travel over a transient road feature such as discontinuous pavement.

If a vehicle experiences significant aerodynamic lift forces or down forces during travel at high speeds, then measurements of vehicle speed may be used to calculate a speed-dependent aerodynamic force contribution, F_{L}(ν), using an equation such as equation (2), where F_{L} is an aerodynamic contribution to the normal force between a vehicle and a surface (lift forces being positive, down forces being negative), ν is the vehicle's speed, ρ is a nominal air density, A is the vehicle's frontal area, and C_{Lf} and C_{Lr} are the vehicle's front and rear axle lift coefficients, respectively.

$${F}_{L} ( v ) = \frac{1}{2} {ρ}^{2} ( {C}_{Lf} + {C}_{Lr} ) {Av}^{2} \qquad ( 2 )$$

The coefficients in such an estimate may be nominal values derived from test data, so that the force balance can be improved by obtaining measurements from existing vehicle sensors, e.g., wheel speed sensors, and incorporating the calculated force contribution into a more detailed force balance such as that shown in equation (3).

N_{fl}+N_{fr}+Nᵣₗ+Nᵣᵣ+F_{L}(ν)=m_{T}g (3)

Subcombinations of the measured tire normal forces and other force contributions may be used to calculate vehicle inertial parameters such as the mass proportioned between a vehicle's front and rear axles using equations (4) through (6) (for brevity's sake, the components of the proportioned mass are described using the terms “front mass” and “rear mass” herein), where the subscripts f and r denote the front and rear components of the indicated properties.

$$\begin{matrix}{F}_{Lf} ( v ) = \frac{1}{2} {ρ}^{2} {C}_{Lf} {Av}^{2} & ( 4 ) \\ {N}_{fl} + {N}_{fr} + {F}_{Lf} ( v ) = {m}_{Tf} g & ( 5 ) \\ {m}_{T} - {m}_{Tf} = {m}_{Tr} & ( 6 )\end{matrix}$$

As shown, the front mass, m_{Tf}, may be subtracted from the total vehicle mass to calculate the rear mass, m_{Tr}, however similar calculations could instead subtract the rear mass from the total vehicle mass to calculate the front mass, or calculate each of the masses without reference to the others. It is important to note that during significant longitudinal acceleration/deceleration equations (5) and (6) will not yield information pertaining to the desired quasi-static value of mass proportioned between axles due to load transfer between the axles of the vehicle.

In addition, combinations of measurements of tire normal forces and vehicle lateral acceleration may be used to calculate vehicle inertial parameters such as the height of the vehicle center of mass. For example, by summing forces and moments in a transverse plane under conventional cornering conditions, i.e., during quasi-steady state cornering maneuvers involving gradual changes in lateral acceleration, an equation such as equation (7) may be used, where h is the height of the vehicle center of mass, a_{y} is a measured lateral acceleration, and t_{w} is an average track width between the left side and right side wheels.

$${N}_{lf} - {N}_{rf} + {N}_{lr} - {N}_{rr} = \frac{2 {m}_{T} {a}_{y}}{{t}_{w}} h \qquad ( 7 )$$

It is important to note that during quick cornering or avoidance maneuvers the assumptions underlying equation (7) will not be satisfied due to the effect of body roll inertia. It should also be apparent that during straight line driving or slight track adjustments equation (7) will not yield a meaningful value for the height of the vehicle center of mass.

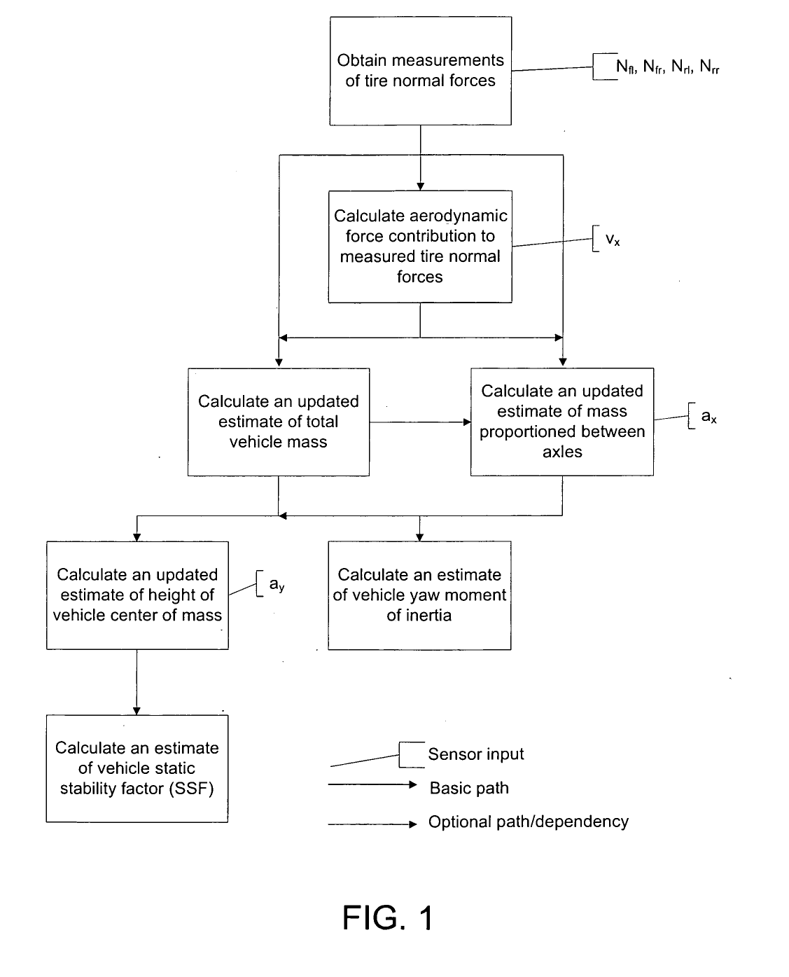

As shown, equations such as equations (1) through (7) may be used to estimate vehicle mass characteristics and the height of the vehicle center of mass. However it will be recognized that since all measured values are subject to measurement noise and other errors, a calculated instantaneous value of a vehicle inertial parameter such as total vehicle mass will tend to be inaccurate, so that some form of time average must be used to calculate an estimated value in order to improve overall accuracy. That is, starting with initial values corresponding to the nominal values of these parameters, a time average is calculated each time a new sampling of the vehicle's tire forces becomes available, so that after sufficiently long times the estimated values of a vehicle's inertial parameters converge to the true values. Parameter estimation calculations may be performed at low sampling rates corresponding to those at which tire forces are obtained from the tire sensors (generally once per full revolution of a wheel), but provide information pertinent to calculations that must be performed at high sampling rates, as will be described in further detail below. The calculations may be performed by a computing device, which may be a VSC system and/or an accessory computing device in communication with a VSC system, configured to perform the generalized steps of:
1. Obtaining measurements of tire normal forces,
2. Calculating non-gravitational contributions to the measured tire normal forces,
3. Calculating updated estimates of the total vehicle mass and the mass proportioned between axles,
4. Calculating an updated estimate of the vehicle yaw moment of inertia,
5. Obtaining a measurement of lateral acceleration during quasi-steady state cornering and calculating an updated estimate of the height of the vehicle center of mass,
6. Calculating an updated estimate of the vehicle static stability factor, and
7. Performing a vehicle stability control calculation using a dynamically calculated estimate of a vehicle inertial parameter.
   FIG. 1 sets out a flow chart for a generalized implementation of the method, showing input measurements, output values, and interrelationships between method steps. Each of the listed steps is described in further detail below. Not all of the described steps need be performed in the discussed methods, and not all the described steps need necessarily be completed in the discussed order in order to obtain a useful result.

In the first step of a method using measurements of tire normal forces, the computing device obtains measurements of tire normal forces from the tires of a vehicle. The computing device may obtain such measurements by monitoring information from sensor groups embedded within intelligent tires and calculating the measurement itself, for example by determining the size of the tire contact patch and tire pressure (e.g., as shown in U.S. Pat. No. 5,913,240) or by combining information from strain sensors embedded in the tires and mathematical or engineering models to convert the measured strains into forces (e.g., as shown in U.S. Pat. Nos. 6,967,590 and 6,959,593). The computing device may alternately monitor a measurement calculated by a separate computing device such as a tire monitor, or by performing further calculations on information calculated by such a separate computing device.

In a second step, the computing device may calculate the contributions of any significant non-gravitational forces affecting the measured tire normal forces to reduce systematic error in the analysis of the inertial property. For example, if a vehicle experiences significant aerodynamic lift or down forces during travel at high speed, then the computing device may calculate the total speed-dependent aerodynamic lift force from equation (2) and the lift force per axle from equations similar to equation (4).

In a third step, the computing device calculates estimates, i.e., time-averaged values, of total vehicle mass and mass proportioned between axles. Those skilled in the art will recognize that the measured information described herein is generally subject to measurement noise, and on occasion collected during conditions where the measured data is not indicative of the vehicle inertial property that is being analyzed. Estimation steps such as the present step are used to reduce the effects of measurement noise and transient systematic errors, i.e., non-representative calculations performed when the vehicle experiences conditions which violate the assumptions in the analysis, and produce quasi-static estimates of the vehicle's inertial parameter values. Such estimates may be calculated using a technique such as an arithmetic mean, but preferably these calculations are performed using a recursive algorithm, so that the averaged value of the vehicle parameter is corrected toward the actual value of the property as new measurements and calculations/observations are pooled with the prior averaged value. Advantageously, the use of a recursive algorithm permits such a calculation to be performed in real-time and without the need to store a large pool of calculated values. For example, the averaged value of a generalized scalar vehicle parameter θ may be updated using a recursive least squares estimator such as the one shown in equations (8a) and (8b), where \hat{θ}(tₖ) and \hat{θ}(tₖ₋₁) represent the averaged value of the parameter at a current and previous instant in time, respectively, and φ(tₖ) represents a constant or function relating the averaged value to a calculated value/observation y(tₖ) such that y(tₖ)≈φ(tₖ)\hat{θ}(tₖ).

$$\begin{matrix}\hat{θ} ( {t}_{k} ) = \hat{θ} ( {t}_{k - 1} ) + P ( {t}_{k} ) ϕ ( {t}_{k} ) [ y ( {t}_{k} ) - ϕ ( {t}_{k} ) \hat{θ} ( {t}_{k - 1} ) ] & ( 8 a ) \\ P ( {t}_{k} ) = \frac{P ( {t}_{k - 1} )}{1 + {ϕ}^{2} ( {t}_{k} ) P ( {t}_{k - 1} )} & ( 8 b )\end{matrix}$$

The initial value for the parameter \hat{θ}(tₖ₋₁) may be set to an appropriate nominal value, such as a nominal total vehicle mass, and the initial value for the weight factor P(tₖ₋₁) may be set to a small positive value. The difference between the currently calculated value/observation y(tₖ) and a predicted value for the current observation φ(tₖ)\hat{θ}(tₖ₋₁) is used to update the averaged or initial value \hat{θ}(tₖ₋₁) to the new averaged value \hat{θ}(tₖ), with the difference being weighted by P(tₖ) to have less significance as the population of calculated values that has contributed to the recursively determined average rises over time. Further detail concerning the use of \hat{θ}(tₖ), φ(tₖ), and y(tₖ) will be apparent from the exemplary calculations described below.

Also advantageously, the use of a recursive algorithm permits the averaging process to be made adaptive through selective weighting of the current calculation/observation. When an observation is considered reliable, with a high signal to noise ratio, the calculated value may be weighted so that the averaged value converges normally toward the likely true value, whereas when an observation is considered unreliable, and collected during conditions which appear to violate the assumptions behind the method for analyzing the property, the calculated value may be weighted so that it is discounted or even discarded. The weighting may be accomplished, for example, by modifying equations (8a) and (8b) to incorporate an additional weight factor, γ, such as in equations (9a) and (9b), with γ varying between 1 and 0.

$$\begin{matrix}\hat{θ} ( {t}_{k} ) = \hat{θ} ( {t}_{k - 1} ) + P ( {t}_{k} ) ϕ ( {t}_{k} ) γ [ y ( {t}_{k} ) - ϕ ( {t}_{k} ) \hat{θ} ( {t}_{k - 1} ) ] & ( 9 a ) \\ P ( {t}_{k} ) = \frac{P ( {t}_{k - 1} )}{1 + {ϕ}^{2} ( {t}_{k} ) γ P ( {t}_{k - 1} )} & ( 9 b )\end{matrix}$$

When γ is set to 1, the difference between the currently calculated value/observation y(tₖ) and a predicted value for the current observation is given full weight, so that the averaged value \hat{θ}(tₖ₋₁) is updated to \hat{θ}(tₖ) using the entirety of the difference. When γ is set to 0, the currently calculated value/observation is essentially discarded, with \hat{θ}(tₖ)=\hat{θ}(tₖ₋₁) and P(tₖ)=P(tₖ₋₁).

With reference by way of example to equations (3) and (5), an estimated vehicle mass may be calculated using equations (8a) and (8b) with:

y(t)=N_{lf}+N_{rf}+Nₗᵣ+Nᵣᵣ+F_{L}(ν); φ(t)=g; θ=m_{T} (10)

and an estimated front axle mass may be calculated using equations (8a) and (8b) with:

y(t)=N_{lf}+N_{rf}+F_{Lf}(ν); φ(t)=g; θ=m_{Tf} (11)

Because equations (3) and (5) are written in terms of force and weight, y(tₖ) is the estimate of m_{T} or m_{Tf}, respectively, and φ(tₖ)=g. However, if equations (3) and (5) were to be used to calculate static weights, then y(tₖ) would be an calculated value of m_{T}g or m_{Tf}g, respectively, and φ(tₖ)=1. Those skilled in the art will recognize that various permutations of these equations may be used to calculate estimated masses or estimated static weights. Those reviewing this description will also recognize that, when using a recursive algorithm, the calculation and use of y(tₖ) and φ(tₖ) is mathematically identical to an explicit calculation of θₖ, so that the calculation of a recursively averaged value may be considered to include the calculation of a non-averaged value such as the total vehicle mass from equation (3) above.

Preferably the mass proportioned between axles is calculated using an adaptive average, i.e., equations (9a) and (9b), as a means for actively discounting values calculated during conditions which appear to violate the assumptions made in the analysis of the property. For example, when the apparent longitudinal acceleration/deceleration of the vehicle exceeds predetermined threshold values, load transfer between axles will cause the calculated mass proportioned between axles to become non-representative of the actual property and desired quasi-static estimate. Therefore when estimating a front axle mass using equations (9a), (9b), and (11), the value of γ may be varied according to a rule such as rule (12), where aₓ represents a measured or calculated longitudinal acceleration, aₓₜₕᵣₑ₁ represents a predetermined first threshold, and aₓₜₕᵣₑ₂ represents a predetermined second threshold.

$$γ ( {a}_{x} ) = \{ \begin{matrix}1 & when \vert {a}_{x} \vert \leq {a}_{xthre 1} \\ \frac{{a}_{xthre 2} - \vert {a}_{x} \vert}{{a}_{xthre 2} - {a}_{xthre 1}} & when {a}_{xthre 1} < \vert {a}_{x} \vert < {a}_{xthre 2} \\ 0 & when \vert {a}_{x} \vert \geq {a}_{xthre 2 }\end{matrix} \qquad ( 12 )$$

The predetermined threshold values of aₓₜₕᵣₑ₁ and aₓₜₕᵣₑ₂ may be set to 1.0 m/s² and 2.0 m/s², respectively, and the value of aₓ may be measured by an accelerometer or calculated by monitoring changes in vehicle speed derived from wheel speed sensors. In the preferred approach, values calculated using force measurements obtained during significant longitudinal acceleration/deceleration within the range of aₓₜₕᵣₑ₁ and aₓₜₕᵣₑ₂ would be discounted during calculation of the average, being somewhat representative but somewhat unreliable, and values calculated during longitudinal acceleration/deceleration exceeding aₓₜₕᵣₑ₂ would be discarded, since under such circumstances the sum of the applicable tire normal forces would fail to be representative of the vehicle's static loading condition.

In a fourth step, the computing device may calculate an estimate of the vehicle yaw moment of inertia using the calculated mass values and other known vehicle properties. For example, in a four-wheeled vehicle the estimated total vehicle mass m_{T} and front axle mass m_{Tf} may be combined with the dimensions of the vehicle wheelbase and a nominal vehicle yaw moment of inertia to estimate an actual vehicle yaw moment of inertia. Initially, an estimate of the location of the vehicle center of mass along the longitudinal axis and the distances between the front and rear axles and the vehicle center of mass may be determined using equations such as equations (13) and (14), where L is the length of the vehicle wheelbase, m_{T} and m_{Tf} are estimated masses, d_{f} is the distance of the center of mass from the front axle, and dᵣ is the distance of the center of mass from the rear axle.

$$\begin{matrix}{d}_{r} = L \frac{{m}_{Tf}}{{m}_{T}} & ( 13 ) \\ {d}_{f} = L - {d}_{r} & ( 14 )\end{matrix}$$

Subsequently, the vehicle yaw moment of inertia may be estimated through an equation such as equation (14), where I_{zz} is an estimated vehicle yaw moment of inertia, m_{T} is the estimated total vehicle mass, and I_{zznom}, mₙₒₘ, d_{fnom} and dᵣₙₒₘ are nominal values for the indicated vehicle properties.

$${I}_{zz} = {I}_{zznom} \frac{{m}_{T} {d}_{f} {d}_{r}}{{m}_{nom} {d}_{fnom} {d}_{rnom}} \qquad ( 15 )$$

Equation (15) is based on the observation that for most passenger vehicles, the yaw moment of inertia is approximately proportional to the product of the total vehicle mass and the distances between the vehicle center of mass and the front and rear axles. Of course, with appropriate modifications, equations similar to equations (13) through (15) could be used to estimate the vehicle yaw moment of inertia using an estimated rear axle mass, m_{Tr}, instead of an estimated front axle mass, m_{Tf}. Also, with appropriate additional steps, equations similar to equations (3) through (6) and (13) through (15) could be combined with equations (8a) and (8b) or (9a) and (9b) to calculate an estimate without an explicit intermediate calculation of estimated masses.

In a fifth step, the computing device may calculate an estimate of the height of the vehicle center of mass. Preferably the estimate is calculated using a recursive algorithm such as the one presented in the third step above. With reference by way of example to equation (7), the estimate may be calculated using equations (8a) and (8b) or (9a) and (9b) with:

$$y ( t ) = {N}_{lf} - {N}_{rf} + {N}_{lr} - {N}_{rr} ; \\ ϕ ( t ) = \frac{2 {m}_{T} {a}_{y}}{{t}_{w}} ; \\ θ = h \qquad ( 16 )$$

Note that the variable φ(t) includes the total vehicle mass, and is preferably calculated using the estimated total vehicle mass, the calculation of which is described in the third step above. Those reviewing this description will again recognize that, when using a recursive algorithm, the calculation and use of y(tₖ) and φ(tₖ) is mathematically identical to an explicit calculation of θₖ, so that the calculation of a recursively averaged value for height of the vehicle center of mass may be considered to include the calculation of a non-averaged height of the vehicle center of mass from equation (7) above.

If a recursive algorithm is used, the estimate may be calculated using an adaptive recursive average, i.e., equations (9a) and (9b), as a means for actively discounting values calculated during conditions which appear to violate the assumptions made in the analysis of the property. The weighting factor γ in this instance may be the product of the two weighting factors, such that γ=γ₁γ₂, with both weighting factors varying independently between 1 and 0. The first weighting factor γ₁ may vary with the magnitude of the measured lateral acceleration to prevent the estimate from being updated during periods of straight driving or slight track adjustment, when signal to noise ratio is likely at a minimum and the exemplary method of analysis yields indeterminate results. For example, the value of γ₁ may be varied according to a rule such as rule (17), where a_{ythre1} represents a predetermined first threshold and a_{ythre2} represents a predetermined second threshold.

$${γ}_{1} ( {a}_{y} ) = \{ \begin{matrix}0 & when \vert {a}_{y} \vert \leq {a}_{ythre 1} \\ \frac{\vert {a}_{y} \vert - {a}_{ythre 1}}{{a}_{ythre 2} - {a}_{ythre 1}} & when {a}_{ythre 1} < \vert {a}_{y} \vert < {a}_{ythre 2} \\ 1 & when \vert {a}_{y} \vert \geq {a}_{ythre 2 }\end{matrix} \qquad ( 17 )$$

The predetermined values of a_{ythre1} and a_{ythre2} may be set to 0.5 m/s² and 1.5 m/s², respectively, and the value of a_{y} may be measured using a lateral accelerometer already present in typical VSC systems. The second weighting factor γ₂ may act as a low-pass filter to prevent the averaged estimate from being updated during quick cornering or avoidance maneuvers, where the assumptions behind equation (15) are not satisfied due to body roll inertia. The measured lateral acceleration, a_{y}, may be numerically filtered to approximate its derivative, a_{yder}, and the value of γ₂ may be varied according to a rule such as rule (18), where a_{yderthre1} represents a predetermined first threshold and a_{yderthre2} represents a predetermined second threshold.

$${γ}_{2} ( {a}_{yder} ) = \{ \begin{matrix}1 & when \vert {a}_{yder} \vert \leq {a}_{yderthre 1} \\ \frac{{a}_{yderthre 2} - \vert {a}_{yder} \vert}{{a}_{yderthre 2} - {a}_{yderthre 1}} & when {a}_{yderthre 1} < \vert {a}_{yder} \vert < {a}_{yderthre 2} \\ 0 & when {a}_{yderthre 2 } \geq \vert {a}_{yder} \vert\end{matrix} \qquad ( 18 )$$

The predetermined values of a_{yderthre1} and a_{yderthre2} may be set to 2.0 M/s³ and 4.0 m/s³, respectively. The rate of decrease in a_{yder} may also be limited, with a rate-of-change limited value a_{yder lim} being substituted for a_{yder} in rule (18). Such a rate-of-change limited value may improve accuracy by allowing new measurements to continue to be discounted during or immediately following quick transient maneuvers, when the value of a_{yder} may fall between +a_{yderthre1} and −a_{yderthre1} during a reversal in direction, and when the vehicle body may still be undergoing transient roll oscillations after a quick transient maneuver.

In a sixth step, the computing device may calculate an estimate of the vehicle static stability factor. The static stability factor is typically calculated using an equation such as equation (19), where h is an estimated height of the vehicle center of mass and t_{w} is an average track width between the left side and right side wheels.

$$SSF = \frac{{t}_{w} / 2}{h} \qquad ( 19 )$$

Of course, with appropriate additional steps, equations similar to equations (7) and (19) could be combined with equations (8a) and (8b) or (9a) and (9b) to calculate an estimate without an explicit intermediate calculation of an estimated height of the vehicle center of mass.

In a seventh step, the computing device may, if a VSC system itself, perform a calculation using one of the above described estimated vehicle parameters (total vehicle mass, mass proportioned between axles (that is front mass and/or rear mass), vehicle yaw moment of inertia, height of the vehicle center of mass, and vehicle static stability factor) or, if an accessory computing device in communication with a VSC system, transmit one of the above described estimated vehicle parameters to the VSC system for use in a vehicle stability control calculation. The estimated vehicle parameter, being determined from analyses of the actual vehicle property, will tend to provide more accurate information concerning the vehicle's dynamic behavior to the VSC system than a pre-programmed nominal value after an initial period of operation and data collection.

Example results from simulations performed using the CARSIM® vehicle simulation environment marketed by the Mechanical Simulation Corporation of Ann Arbor, Mich. are provided in order to illustrate an application of the disclosed method. Vehicle properties for a Chevrolet Silverado pick up truck were used, including the nominal and actual vehicle properties shown in Table 1. The nominal values correspond to the properties of a fully loaded vehicle, while the actual values correspond to the properties of a vehicle loaded with one driver, one passenger, and no cargo. The average track width of the simulated vehicle was 1.73 m, and no non-gravitational contributions to tire normal forces were calculated.

TABLE 1
Vehicle inertial parameters in simulation.

| | | | | | | | Height of |
|---|---|---|---|---|---|---|---|
| | | Front Axle | Rear Axle | Distance | Distance | Moment of | Center of |
| | Mass | Mass | Mass | (Eq. (13)) | (Eq. (12)) | Inertia | Mass |
| | m_{T} (kg) | m_{Tf} (kg) | m_{Tr}(kg) | d_{f} (m) | dᵣ (m) | I_{zz} (kg · m²) | h (m) |
| nominal | 2952 | 1511 | 1441 | 1.79 | 1.87 | 10460 | 0.730 |
| actual | 2349 | 1312 | 1037 | 1.62 | 2.04 | 7410 | 0.714 |

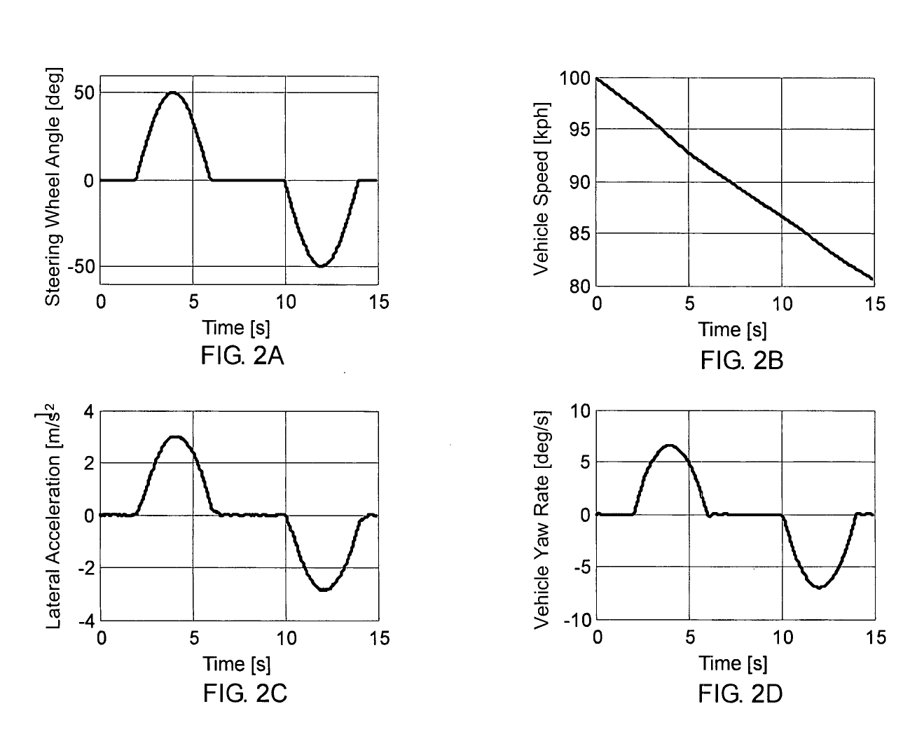

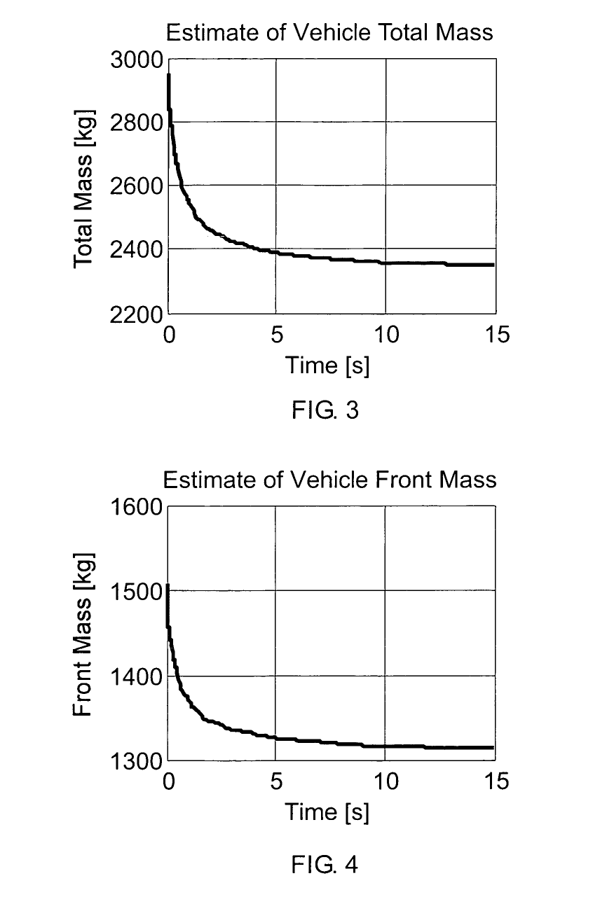

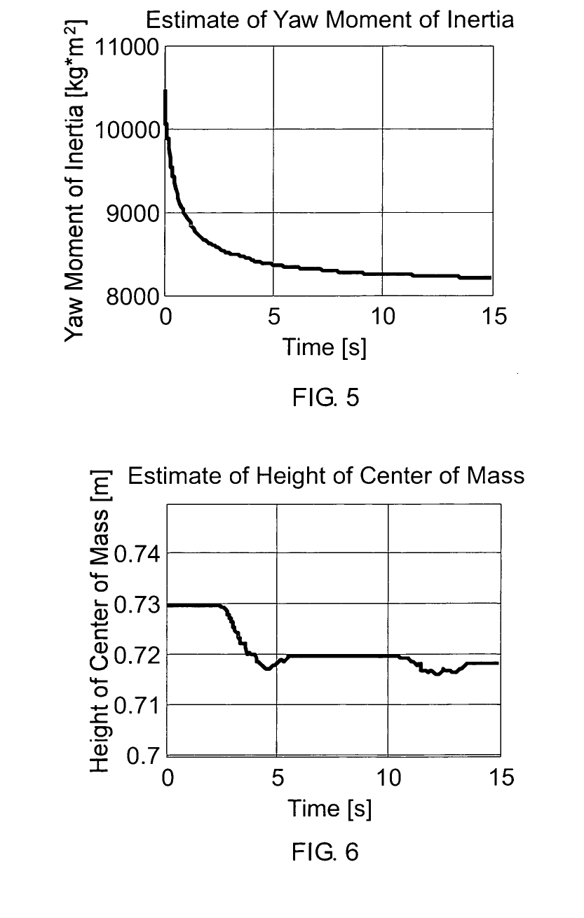

Vehicle travel was simulated for a 15 second time period with an initial vehicle speed of 100 kph and no applied throttle. The simulated travel consisted of travel over a smooth and level surface, and included two oppositely-directed slow-rate turning maneuvers. FIGS. 2A-2D show ‘measured’ values of steering wheel angle, vehicle speed, lateral acceleration, and vehicle yaw rate during the simulated interval. Tire normal forces were used to calculate estimates of inertial parameters according to equations (2) through (7) and (13) through (15) using a recursive averaging algorithm (eq. (8)) for the calculation of the estimated total mass of vehicle, using an adaptive recursive averaging algorithm (eq. (9)) for the calculation of the estimated front and rear masses, moment of inertia and height of the vehicle center of mass, and using rules (12), (17), and (18) with the disclosed exemplary values. FIG. 3 shows the evolving estimate of total vehicle mass, which is initially equal to the nominal total vehicle mass, but is updated over time to approximate the actual total vehicle mass. FIGS. 4, 5, and 6 show the evolving estimates of front mass, vehicle yaw moment of inertia, and height of the vehicle center of mass. It is important to note that the estimate of the height of the vehicle center of mass remains equal to the nominal value until the vehicle has committed to a first cornering maneuver at t≈3 seconds, at which time lateral acceleration begins to exceed an exemplary predetermined first threshold of a_{ythre1}=0.5 m/s². For each parameter, the estimated value approximates the actual vehicle property after approximately 15 seconds of operation and data collection, although the time required to estimate a height of the vehicle center of mass will obviously depend upon the time elapsing before the execution of a significant cornering or steering maneuver in real-world use.

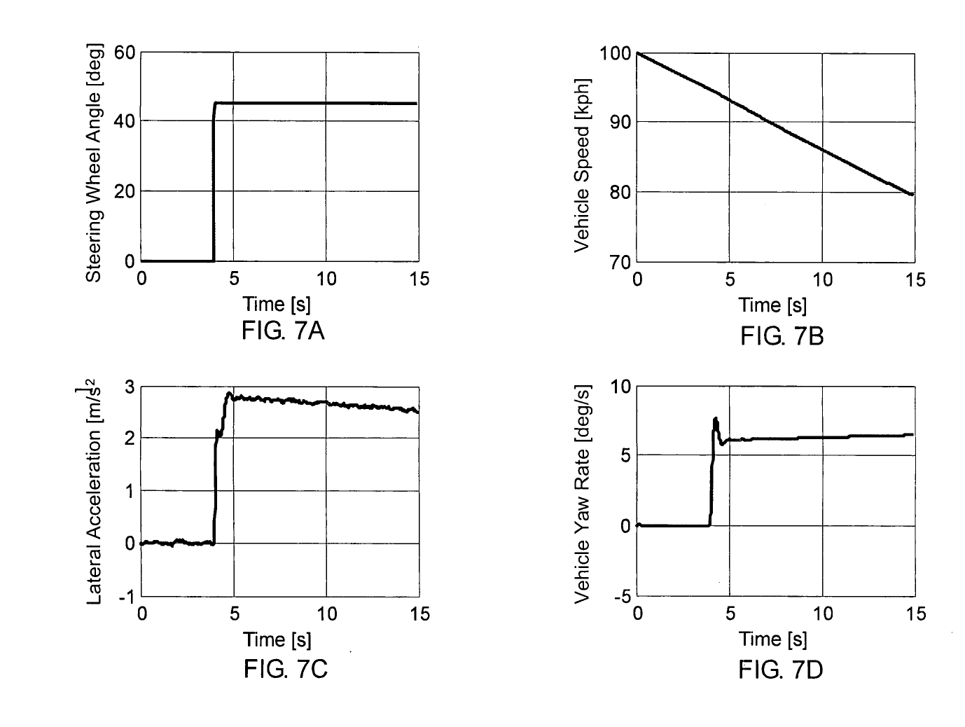

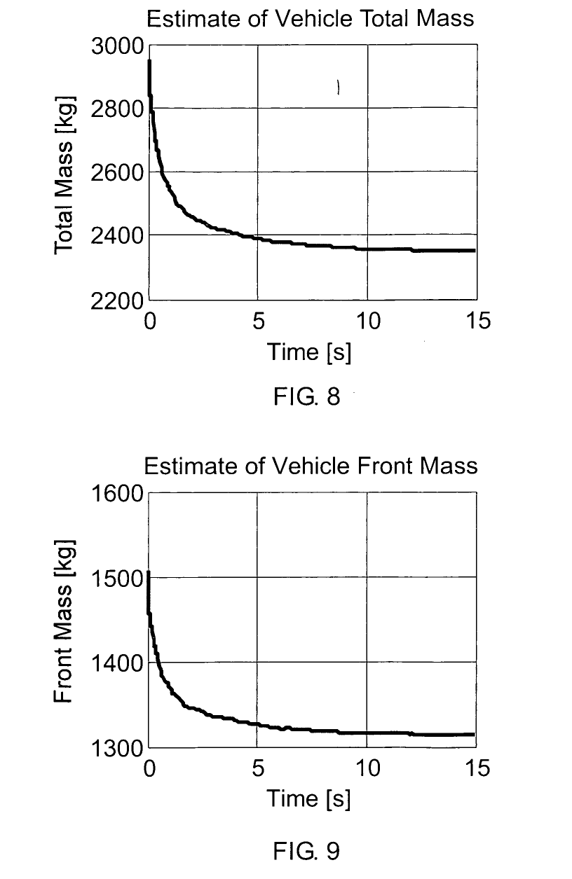

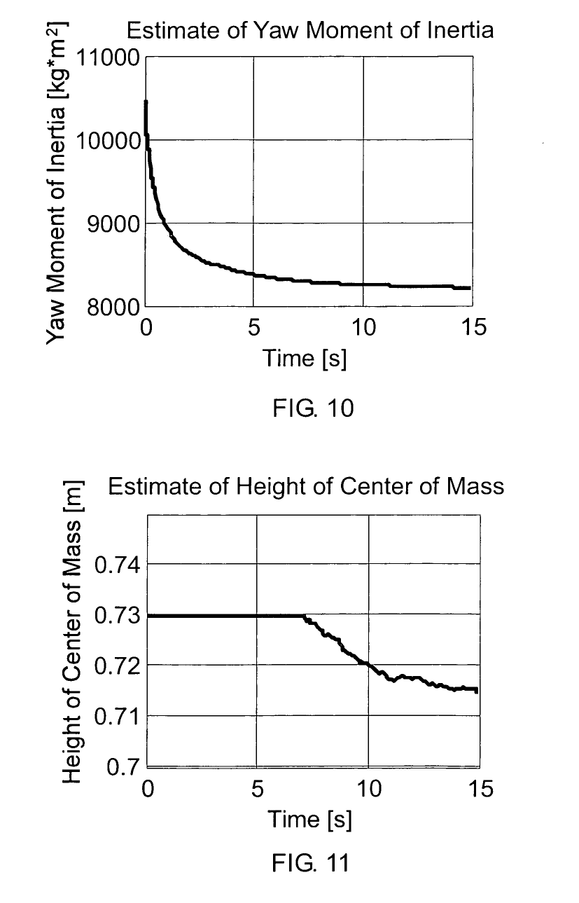

In a second scenario, the simulated travel was altered to include only a single ‘step steer’ maneuver, consisting of 4 seconds of straight line driving followed by rapid entry into a slow-rate turning maneuver. FIGS. 7A-7D show ‘measured’ values of steering wheel angle, vehicle speed, lateral acceleration, and vehicle yaw rate during the simulated interval, and vehicle inertial parameters were calculated in the same manner as the first scenario. FIGS. 8-11 show the evolving estimates of total vehicle mass, front mass, vehicle yaw moment of inertia, and height of the vehicle center of mass. Even though a_{y} reaches approximately steady-state value at about t=5 s (FIG. 7C), the estimate of h is not updated until about t=7 s. This is because the rate-of-change limited value of the derivative of lateral acceleration, a_{yder lim}, remained above the threshold a_{yderthre2} to about t=7 s.

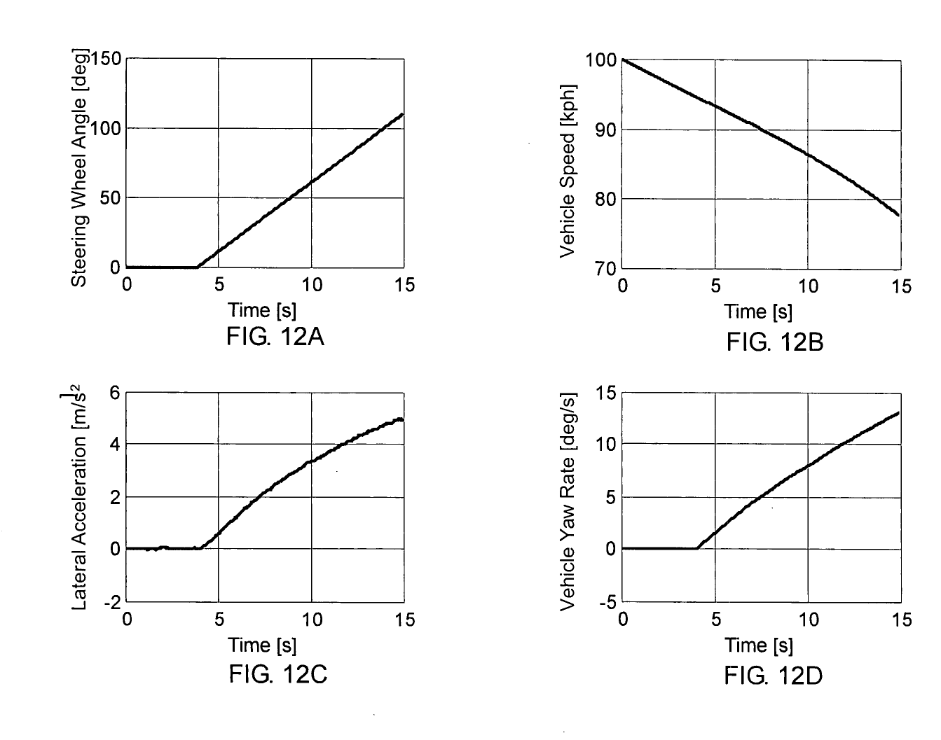

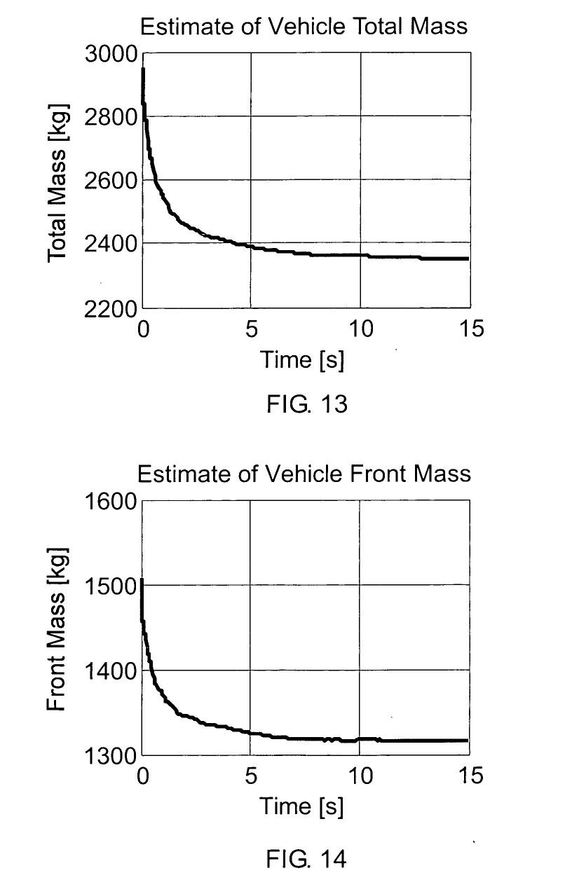

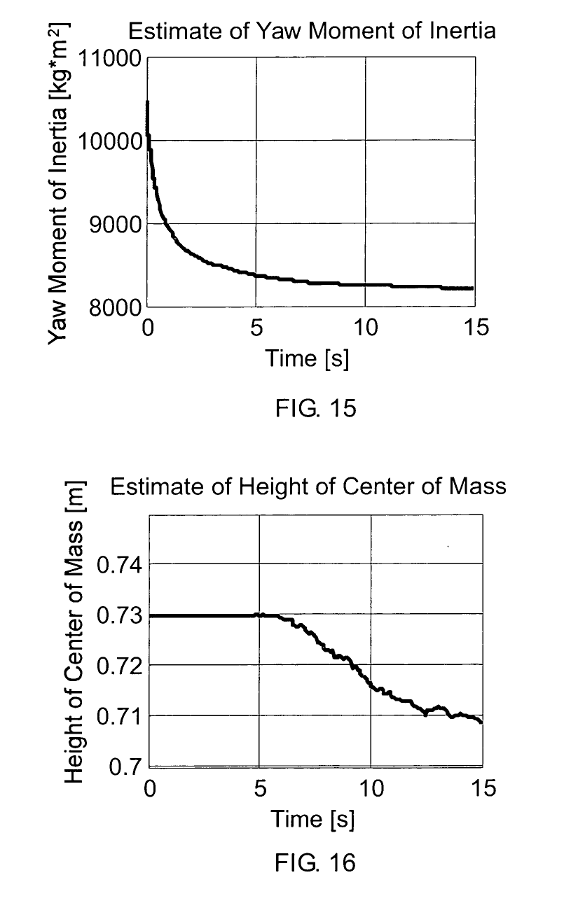

In a third scenario, the simulated travel was altered to include only a single ‘ramp steer’ maneuver, consisting of 4 seconds of straight line driving followed by entry into a increasing-rate turning maneuver. FIGS. 12A-12D show ‘measured’ values of steering wheel angle, vehicle speed, lateral acceleration, and vehicle yaw rate during the simulated interval, and vehicle inertial parameters were calculated in the same manner as the first scenario. FIGS. 13-16 show the evolving estimates of total vehicle mass, front mass, vehicle yaw moment of inertia, and height of the vehicle center of mass. As in the first simulated scenario, the estimate of the height of the vehicle center of mass remains equal to the nominal value until the vehicle has committed to the maneuver at t≈5 seconds, at which time lateral acceleration begins to exceed the exemplary predetermined first threshold of a_{ythre1}=0.5 m/s².

### Estimation of Vehicle Parameters Using Tire Lateral Forces

If a two-axled vehicle such as a passenger car or light truck is considered, then measurements of tire lateral forces may be combined with measurements of lateral acceleration, vehicle yaw rate, and steering angle to calculate quasi-static estimates of inertial parameter values such as total vehicle mass, mass proportioned between axles, and vehicle yaw moment of inertia. Advantageously, the latter measurements may be obtained from sensors already present in typical VSC systems. The fundamental relationships which form the basis of the estimation algorithm are explained below.

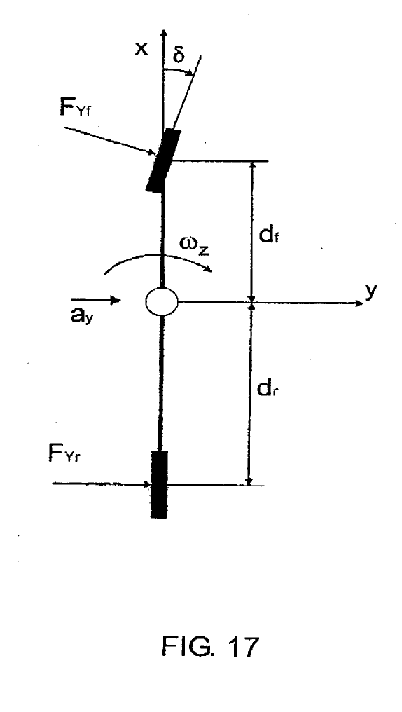

Measurements of tire lateral forces taken at low sampling rates may be combined with other sensor measurements to calculate a near-instantaneous value of a vehicle parameter such as total vehicle mass by employing a bicycle model of vehicle dynamics such as the one shown in FIG. 17, where measured tire lateral forces F_{Yfl} and F_{Yfr}, representing measurements taken from the front left and front right tires, respectively, are added to calculate a measured front axle lateral force, F_{Yf}, and the measured tire lateral forces F_{Yrl} and F_{Yrr}, representing measurements taken from the rear left and rear right tires, respectively, are added to calculate a measured rear axle lateral force, F_{Yr}. Measurements of lateral acceleration, a_{y}, vehicle yaw rate, ω_{z}, and steering angle, δ, which are typically collected during the operation of a VSC system, may be obtained from other vehicle sensors or the VSC system itself. Force and moment balances for the bicycle model are presented in equations (20a) and (20b), where m_{T} is the total vehicle mass, I_{zz} is the vehicle yaw moment of inertia, d_{f} is the distance of the center of mass from the front axle, dᵣ is the distance of the center of mass from the rear axle, and ω_{z} is numerically filtered to approximate its derivative ω_{zder}.

m_{T}a_{y}=F_{Yf} cos δ+F_{Yr} (20a)

I_{zz}ω_{zder}=F_{Yf}d_{f} cos δ−F_{Yr}dᵣ (20b)

These force and moment balances may be combined with relationships between the total vehicle mass, m_{T}, front mass, m_{Tf}, rear mass, m_{Tr}, and wheelbase, L, shown in equations (21a) and (21b), to produce a relationship between front axle lateral force, front mass, and vehicle yaw moment of inertia, shown in equation (22a), and a relationship between rear axle lateral force, rear mass, and vehicle yaw moment of inertia, shown in equation (22b).

$$\begin{matrix}{m}_{Tf} = \frac{{m}_{T} {d}_{r}}{L} & ( 21 a ) \\ {m}_{Tr} = \frac{{m}_{T} {d}_{f}}{L} & ( 21 b ) \\ {F}_{Yf} = \frac{{m}_{T} {d}_{r} {a}_{y} + {I}_{zz} {ω}_{zder}}{L cos δ} = \frac{1}{cos δ} [ {a}_{y} {ω}_{zder} ] [ \begin{matrix}{m}_{Tf} \\ {I}_{zz} / L\end{matrix} ] & ( 22 a ) \\ {F}_{Yr} = \frac{{m}_{T} {d}_{f} {a}_{y} - {I}_{zz} {ω}_{zder}}{L} = [ {a}_{y} - {ω}_{zder} ] [ \begin{matrix}{m}_{Tr} \\ {I}_{zz} / L\end{matrix} ] & ( 22 b )\end{matrix}$$

In each relationship, measured lateral forces are related by functions of measured values to a vector of two unknowns. Therefore equations (22a) and (22b) may be used to calculate near-instantaneous values of front mass, rear mass, and vehicle yaw moment of inertia, with the masses being further combined to calculate a near-instantaneous value of total vehicle mass, if desired. It is important to note that during significant longitudinal acceleration/deceleration equations (22a) and (22b) will not yield information pertaining to the desired quasi-static value of mass proportioned between axles due to load transfer between the axles of the vehicle, with a corresponding change in the tire lateral forces acting to cause the vehicle to turn. It should also be apparent that during straight line driving or slight track adjustments the method will not yield meaningful values for the vehicle inertial parameters. This effect is primarily due to small values of a_{y} and ω_{zder} under these conditions. It should be recognized that while a steering angle, δ, appears in equations (20a), (20b) and (22a), it appears only in the term cos δ, and in most driving conditions does not exceed 10 degrees in magnitude. Therefore when steering angle is not available, an approximation cos δ≈1 can be used with little loss of accuracy.

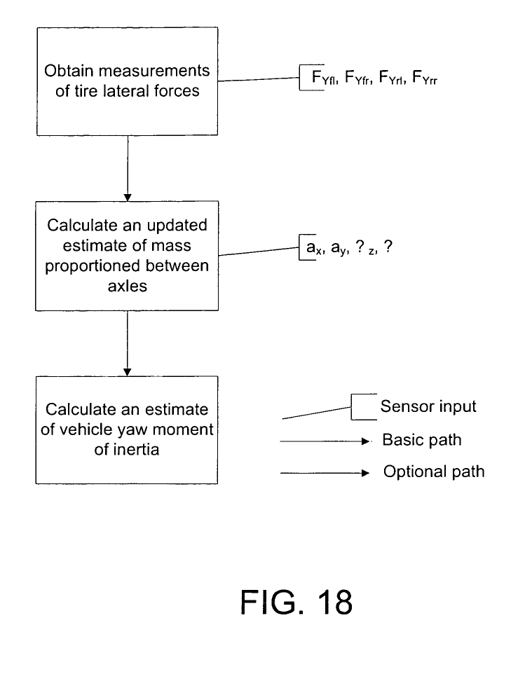

As shown, equations such as equations (20a) through (22b) may be used to estimate vehicle mass characteristics and the height of the vehicle center of mass. However it will be recognized that since all measured values are subject to measurement noise and other errors, a calculated instantaneous value of a vehicle inertial parameter such as total vehicle mass will tend to be inaccurate, so that some form of time average must be used to calculate an estimated value in order to improve overall accuracy. That is, starting with initial values corresponding to the nominal values of these parameters, a time average is calculated each time a new sampling of the vehicle's tire forces becomes available, so that after sufficiently long times the estimated values of a vehicle's inertial parameters converge to the true values. Parameter estimation calculations may be performed at low sampling rates corresponding to those at which tire forces are obtained from the tire sensors (generally once per full revolution of a wheel), but provide information pertinent to calculations that must be performed at high sampling rates, as will be described in further detail below. Such calculations may be performed by a computing device, which may be a VSC system and/or an accessory computing device in communication with a VSC system, configured to perform the generalized steps of:
1. Obtaining measurements of tire lateral forces, lateral acceleration, vehicle yaw rate, and steering angle,
2. Calculating an updated estimate of the mass proportioned between axles,
3. Calculating updated estimates of the total vehicle mass and vehicle yaw moment of inertia,
4. Performing a vehicle stability control calculation using a dynamically calculated estimate of a vehicle inertial parameter.
   FIG. 18 sets out a flow chart for a preferred implementation of the method, showing input measurements, output values, and interrelationships between method steps. Each of the listed steps is described in further detail below. Not all the described steps need necessarily be completed in the discussed order in order to obtain a useful result.

In the first step of a method using measurements of tire lateral forces, a computing device obtains measurements of tire lateral forces from the tires of a vehicle. The computing device may obtain such measurements by monitoring information from sensor groups embedded within intelligent tires and calculating the measurement itself, for example by the methods disclosed in U.S. Pat. Nos. 6,658,927, 6,959,593 and/or 7,168,308, by monitoring a measurement calculated by a separate computing device such as a tire monitor, or by performing further calculations on information calculated by such a separate computing device. Typically, this information will be available at low sampling rates, most frequently only once per full revolution of tire. The computing device also obtains measurements of lateral acceleration, vehicle yaw rate, and steering angle, either directly or indirectly, from other vehicle sensors.

In a second step, the computing device calculates estimates, i.e., time-averaged values, of mass proportioned between axles. As described earlier, estimation steps such as the present step are used to reduce the effects of measurement noise and transient systematic errors, producing quasi-static estimates of the vehicle's inertial parameter values. Preferably this calculation is performed using a recursive algorithm. For example, the averaged value of a generalized parameter vector, θ, may be updated using a recursive least squares estimator such as that shown in equations (23a) and (23b), where \hat{θ}(tₖ) and \hat{θ}(tₖ₋₁) represent the averaged value of the parameter vector at a current and previous instant in time, respectively, φ(tₖ) represents a vector of functions relating the averaged values of the parameter vector to a calculated value/observation y(tₖ) such that y(tₖ)≈φ^{T}(tₖ)\hat{θ}(tₖ), φ^{T}(Tₖ) is the transposed vector φ(tₖ), and I is an identity matrix.

\hat{θ}(tₖ)=\hat{θ}(tₖ₋₁)+P(tₖ)φ(tₖ)−φ(tₖ)└y(tₖ)−φ^{T}(tₖ₋₁)┘ (23a)

P(tₖ)=P(tₖ₋₁)[I+φ(tₖ)φ^{T}(tₖ)P(tₖ₋₁)]⁻¹ (23b)

More preferably the calculation is performed using an adaptive average as a means for actively discounting values calculated during conditions which appear to violate the assumptions made in applying the bicycle model to an analysis of vehicle inertial properties. The weighting may be accomplished, for example, by modifying equations (23a) and (23b) to incorporate an additional weight factor, γ, such as in equations (24a) and (24b), with γ varying between 1 and 0.

\hat{θ}(tₖ)=\hat{θ}(tₖ₋₁)+P(tₖ)φ(tₖ)γ[y(tₖ)−φ^{T}(tₖ)\hat{θ}(tₖ₋₁)] (24a)

P(tₖ)=P(tₖ₋₁)[I+γφ(tₖ)φ^{T}(tₖ)P(tₖ₋₁)]⁻¹ (24b)

The initial value for the parameter \hat{θ}(tₖ₋₁) may be set to a vector of appropriate nominal values, e.g., a nominal front or rear axle mass as a first component and a nominal vehicle yaw moment of inertia (divided by the vehicle wheelbase) as a second component, and the initial value for the weight matrix P(tₖ₋₁) may be set to a small positive definite matrix, for example εI where ε is a small value and I is an identity matrix. Then equations (22a), (24a), and (24b) may be used to calculate estimates of front mass and vehicle yaw moment of inertia with:

$$y ( t ) = {F}_{Yf} ; \\ ϕ ( t ) = \frac{1}{cos δ} [ {a}_{y} {ω}_{zder} ] ; \\ θ = [ \begin{matrix}{m}_{Tf} \\ {I}_{zz} / L\end{matrix} ] \qquad ( 25 a )$$

and equations (22b), (24a), and (24b) may be used to calculate an estimate of rear mass and a second estimate of vehicle yaw moment of inertia with:

$$\begin{matrix}y ( t ) = {F}_{Yr} ; \\ ϕ ( t ) = ⌊ {a}_{y} - {ω}_{zder} ⌋ ; \\ θ = [ \begin{matrix}{m}_{Tr} \\ {I}_{zz} / L\end{matrix} ] & \end{matrix} \qquad ( 25 b )$$

The value of γ in equations (24a) and (24b) may be varied according to rule (26), where aₓ represents a measured or calculated longitudinal acceleration, aₓₜₕᵣₑ₁ represents a predetermined first threshold, and aₓₜₕᵣₑ₂ represents a predetermined second threshold.

$$\begin{matrix}γ ( {a}_{x} ) = \{ \begin{matrix}1 & when \vert {a}_{x} \vert \leq {a}_{xthre 1} \\ \frac{{a}_{xthre 2} - \vert {a}_{x} \vert}{{a}_{xthre 2} - {a}_{xthre 1}} & when {a}_{xthre 1} < \vert {a}_{x} \vert < {a}_{xthre 2} \\ 0 & when \vert {a}_{x} \vert \geq {a}_{xthre 2 }\end{matrix} & \end{matrix} \qquad ( 26 )$$

The predetermined threshold values of aₓₜₕᵣₑ₁ and aₓₜₕᵣₑ₂ may be set to 1.0 m/s² and 3.0 m/s², respectively, and the value of aₓ may be measured by an accelerometer or calculated by monitoring changes in vehicle speed determined from wheel speed sensors. In the preferred approach, values calculated using force measurements obtained during significant longitudinal acceleration/deceleration within the range of aₓₜₕᵣₑ₁ and aₓₜₕᵣₑ₂ would be discounted during calculation of the average, being somewhat representative but somewhat unreliable, and values calculated during longitudinal acceleration/deceleration exceeding aₓₜₕᵣₑ₂ would be discarded, since under such circumstances the tire lateral forces would not be indicative of the vehicle's static loading condition. Of course, the estimated front mass and estimated rear mass may be combined to produce an estimate of total vehicle mass, if desired. Less preferably, near-instantaneous calculations of total vehicle mass (from equation 20a) may be averaged to produce an estimate of total vehicle mass without the explicit calculation of estimated front and rear axle masses, if desired. It should also be recognized that obtaining the estimates of front and rear mass is equivalent to obtaining the location of the vehicle's center of mass relative to vehicle axles, as expressed by distances d_{f} and dᵣ which are directly related to the masses via equations (21a) and (21b).

In a third step, the computing device may calculate an estimate of the vehicle yaw moment of inertia. Two estimates of the vehicle yaw moment of inertia (divided by the vehicle wheelbase, L) are components of the estimate vectors, \hat{θ}(tₖ), calculated in the second step, so that an estimate may be obtained by simply calculating an arithmetic mean of the two estimates to produce a joint estimate. Of course, other methods for combining the estimates could be used or, less preferably, one of estimates could be discarded.

In a fourth step, the computing device may, if a VSC system itself, perform a calculation using one of the above described estimated vehicle parameters (mass proportioned between axles, front mass, rear mass, total vehicle mass, and vehicle yaw moment of inertia) or, if an accessory computing device in communication with a VSC system, transmit one of the above described estimated vehicle parameters to the VSC system for use in a vehicle stability control calculation. As before, the estimated vehicle parameter, being determined from analyses of the actual vehicle property, will tend to provide more accurate information concerning the vehicle's dynamic behavior to the VSC system than a pre-programmed nominal value after an initial period of operation and data collection.

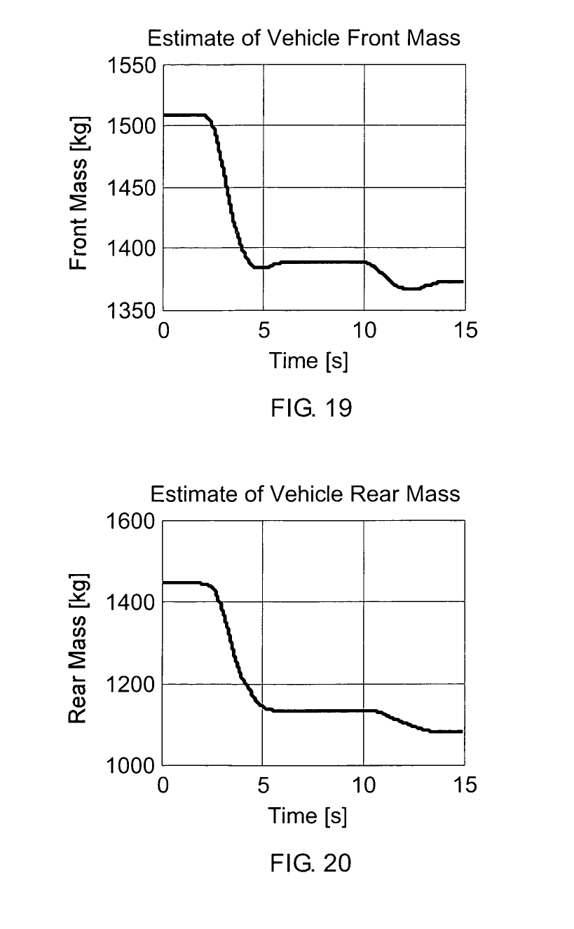

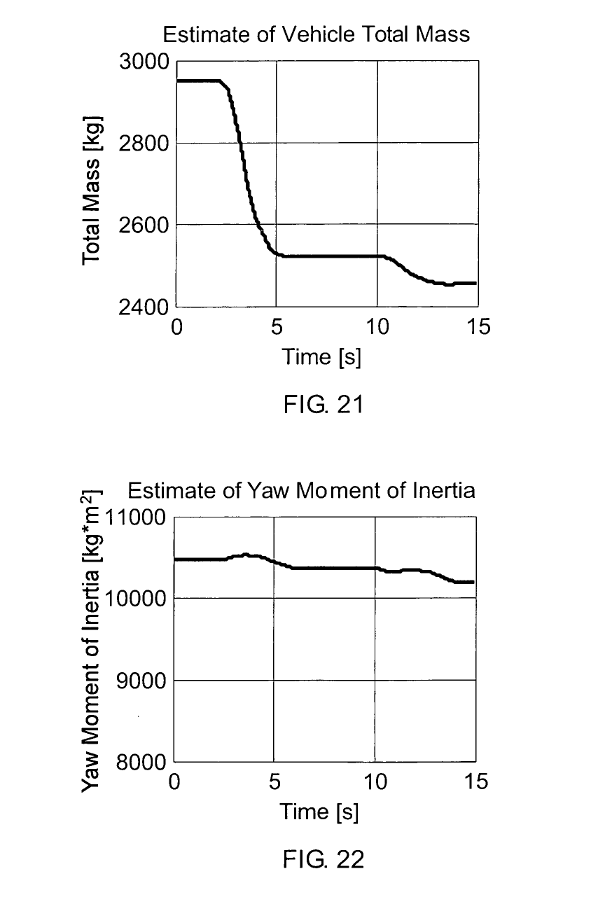

Example results from simulations performed using the CARSIM® vehicle simulation environment are provided in order to illustrate an application of the disclosed method. Vehicle properties and simulation conditions are the same as those introduced previously, so that reference may be made to Table 1 and FIGS. 2A-2D for the nominal vehicle properties, actual vehicle properties, and ‘measured’ values of steering wheel angle, vehicle speed, lateral acceleration, and vehicle yaw rate during the simulated interval. Tire lateral forces were used to calculate estimates of inertial parameters according to equations (22a) and (22b) using an adaptive recursive averaging algorithm according to equations (24a) and (24b) and rule (26) with the disclosed exemplary values. FIG. 19 shows the evolving estimate of front mass, which is initially equal to the nominal front mass, but is updated over time to approximate the actual component of total vehicle mass proportioned between axles. FIGS. 20, 21, and 22 show the evolving estimates of rear mass, total vehicle mass, and vehicle yaw moment of inertia. It is important to note that the estimates remain equal to the nominal values until the vehicle begins a first cornering maneuver at t≈2.5 seconds. For each parameter, the estimated value approaches the actual vehicle property, although it is apparent that the estimate of vehicle yaw moment of inertia approaches the actual property only gradually due to a low rate of change in the vehicle yaw rate (a.k.a., yaw acceleration) during the course of the simulated maneuvers. Additional operation and data collection, with or without more aggressive maneuvering, would tend to further improve the estimate during use of the vehicle.

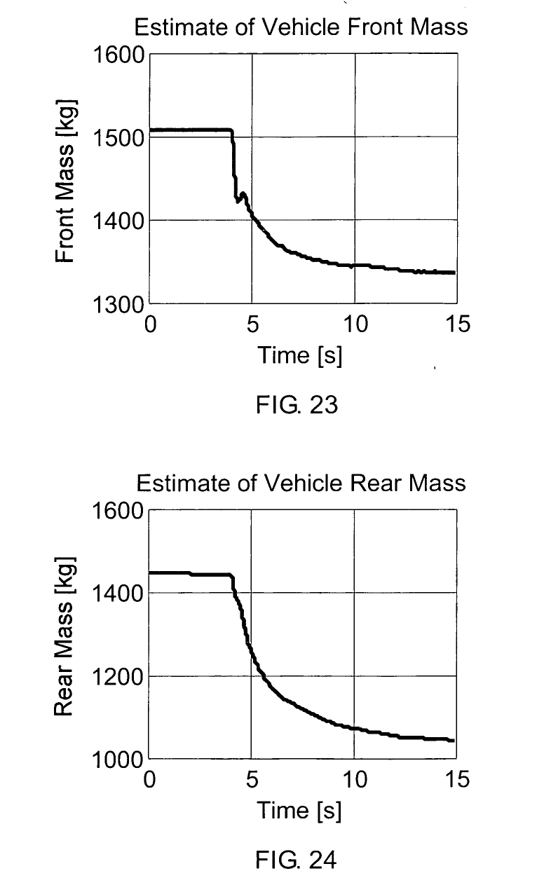

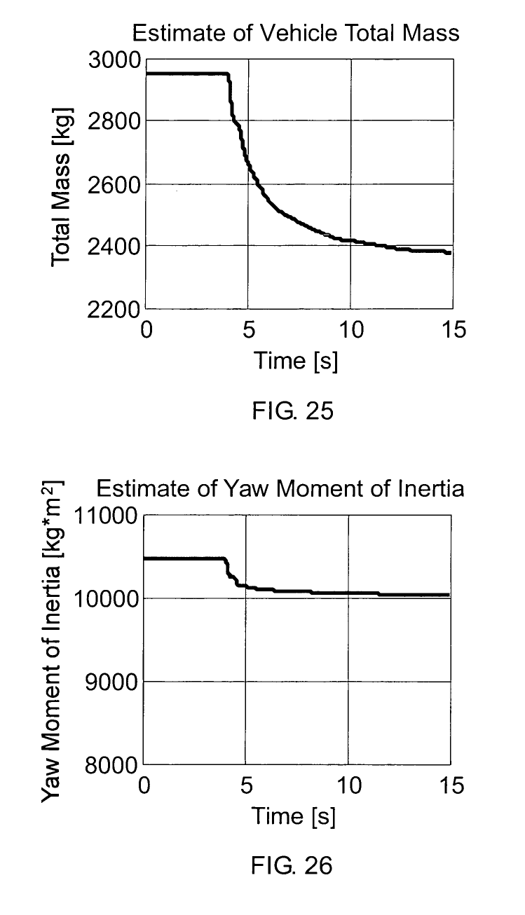

In a second scenario, the simulated travel was again altered to include only a single ‘step steer’ maneuver, consisting of 4 seconds of straight line driving followed by rapid entry into a slow-rate turning maneuver. FIGS. 7A-7D show ‘measured’ values of steering wheel angle, vehicle speed, lateral acceleration, and vehicle yaw rate during the simulated interval, and vehicle inertial parameters were calculated in the same manner as the first scenario. FIGS. 23-26 show the evolving estimates of front mass, rear mass, total vehicle mass and vehicle yaw moment of inertia. In contrast to the first scenario, the estimate of vehicle yaw moment of inertia approaches the actual property more rapidly due to the greater yaw acceleration created by the ‘step steer’ maneuver.

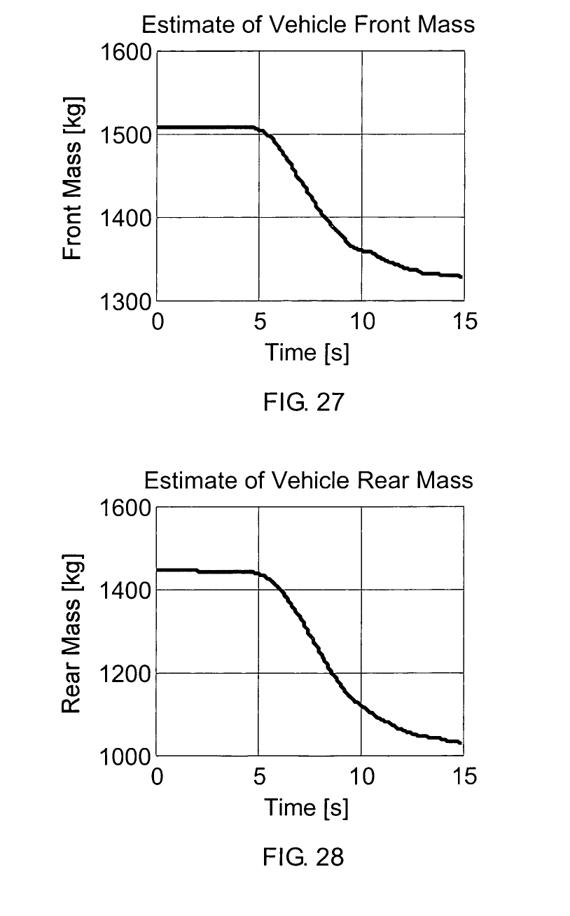

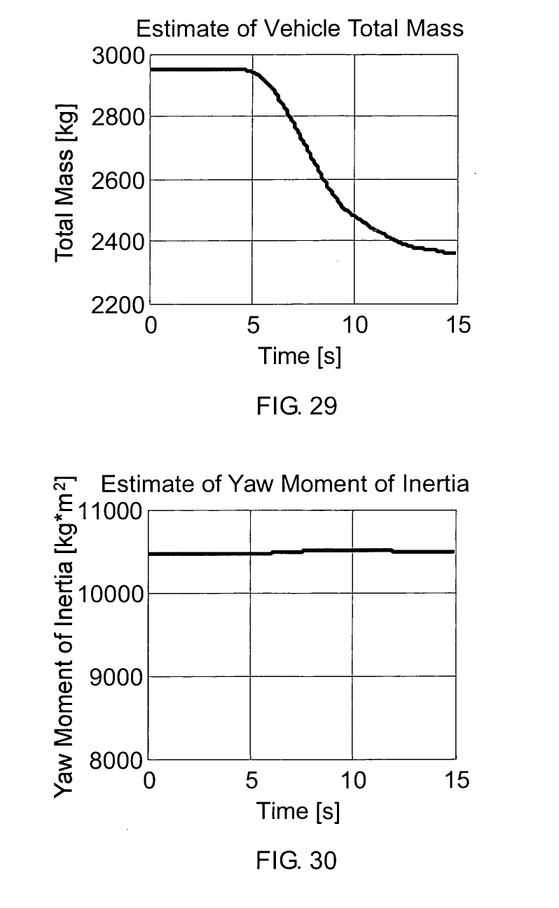

In a third scenario, the simulated travel was again altered to include only a single ‘ramp steer’ maneuver, consisting of 4 seconds of straight line driving followed by entry into a increasing-rate turning maneuver. FIGS. 12A-12D show ‘measured’ values of steering wheel angle, vehicle speed, lateral acceleration, and vehicle yaw rate during the simulated interval, and vehicle inertial parameters were calculated in the same manner as the first scenario. FIGS. 27-30 show the evolving estimates of front mass, rear mass, total vehicle mass and vehicle yaw moment of inertia. It should be noted that the estimate of vehicle yaw moment of inertia remains essentially constant due to a minimal rate of change in the vehicle yaw rate during the course of the simulated maneuver.

### Prediction of Tire Lateral and Normal Forces for Vehicle Control

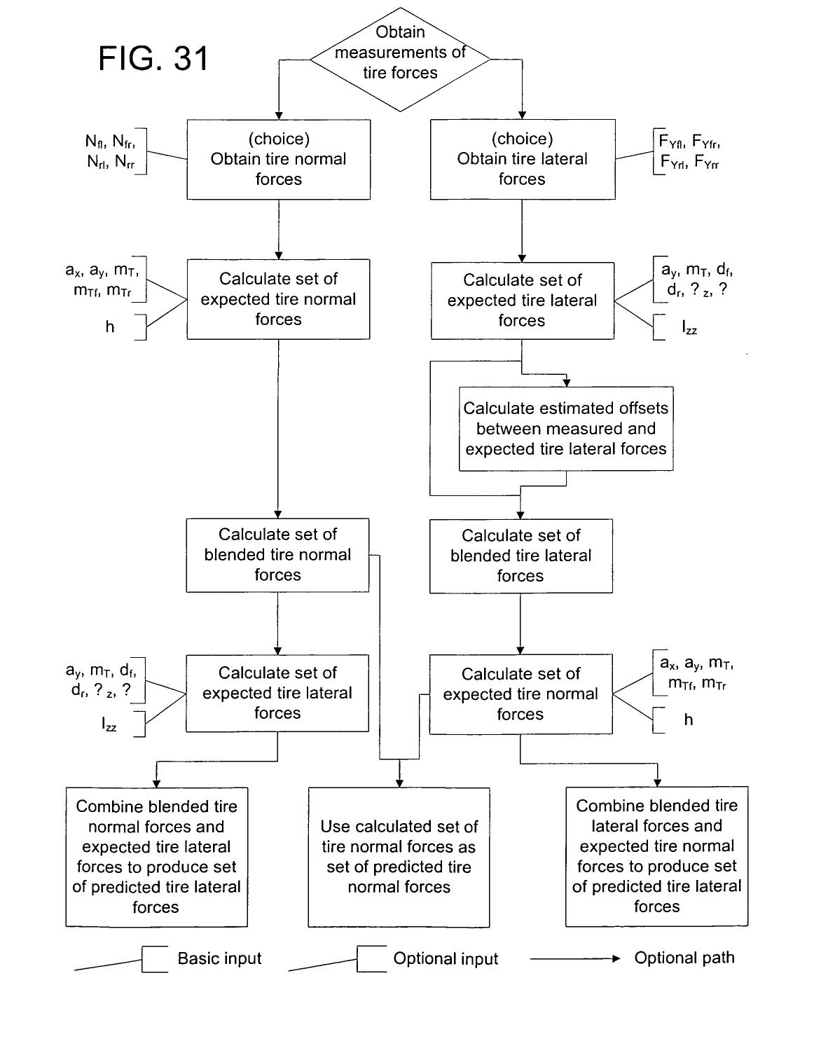

In vehicles equipped with VSC systems, sensor data typically provides measurements of vehicle yaw rate, lateral acceleration, and steering angle at high sampling rates, in the order of 100 Hz, for use in a VSC model of vehicle dynamics and real-time chassis control calculations. Although intelligent tire sensors and methods of calculating tire forces using such sensors are known, those skilled in the art will recognize that the measured tire forces cannot be used directly to enhance chassis control due to the comparatively low sampling rate of the tire sensor groups, which can provide useful data only once per tire revolution—thus typically sampling tire forces at a rate of between 0.5 and 20 Hz, depending upon tire diameter and vehicle speed. In addition, due to cost and other limitations, tire sensors may provide information only about either normal or lateral tire forces, but not both. Yet measured tire forces, estimates of vehicle inertial parameters, and conventional measurements of vehicle yaw rate, acceleration, and steering angle may be combined to produce high data rate predictions of tire lateral and normal forces for use in a VSC system and other chassis control systems. Estimates of tire forces obtained at high sampling rates may be used by VSC systems to improve the distribution of braking forces/torques among vehicle wheels in emergency situations, to detect two-wheel lift off situations, and to improve the performance of brake-based anti-rollover systems. The estimates may also be used by other chassis control systems to detect tire saturation and to improve detection of surface friction, which can allow for better adaptation of control algorithms and the enhancement of performance over a range of driving conditions. Such calculations are preferably performed by the chassis control system, but may be performed in part by an accessory computing device in communication with the chassis control system, and comprise the generalized steps of:
1. Obtaining measurements of either tire lateral forces or tire normal forces,
2. Calculating a corresponding set of expected tire forces using an estimated vehicle inertial parameter and measurements of acceleration, yaw rate, and steering angle,
3. Blending the measured tire forces and the set of expected tire forces to produce a set of blended tire forces,
4. Calculating a set of expected tire forces of the other kind using estimated vehicle mass parameters and measurements of acceleration, yaw rate, and, optionally, steering angle,
5. Combining the set of blended tire forces and a set of calculated tire forces of the other kind to calculate a set of predicted tire forces of the other kind, and
6. Performing a vehicle control calculation using dynamically predicted tire forces.
   FIG. 31 sets out a flow chart for a preferred implementation of the method, showing input measurements and estimates, output values, and interrelationships between method steps. Each of the listed steps is described in further detail below. With the exception of the first step, all steps are preferably performed at high sampling rates.

In the first step of the method, a computing device obtains measurements of tire forces from the tires of a vehicle. As discussed previously, the computing device may obtain such measurements through various means, and may also simply make further use of measurements obtained in the course of estimating a vehicle inertial parameter. The measured tire forces may be either tire normal forces or tire lateral forces and, for the sake of computational simplicity or efficiency, may constitute the same type of tire forces measured during the estimation of a vehicle inertial parameter. Consistent with the prior discussion, measurements of the tire normal forces at the front left, front right, rear left, and rear right tires of a four-wheeled vehicle are denoted by N_{fl}, N_{fr}, Nᵣₗ, and Nᵣᵣ respectively, and measured tire lateral forces taken from the front left and front right tires, F_{Yfl} and F_{Yfr} respectively, may be added to calculate a measured front axle lateral force, F_{Yf}, while measured tire lateral forces taken from the rear left and rear right tires, F_{Yrl} and F_{Yrr} respectively, may be added to calculate a measured rear axle lateral force, F_{Yr}. In contrast to the remaining steps, this step is typically performed at low sampling rates, thus the values of measured tire forces are held constant in the period of time elapsing between samples.

In the second step, the computing device calculates a corresponding set of expected tire forces by combining at least one estimated vehicle inertial parameter and at least one measurement of acceleration, yaw rate, and, optionally, steering angle. Unlike the measured tire forces, which are typically sampled at a rate of between 0.5 and 20 Hz, calculations of the expected tire forces may be performed at data rates equal to the sampling rates of the sensors already present in typical VSC systems, i.e., in the order of 100 Hz, and used to predict tire forces when the measured tire forces become ‘stale’. For example, when measurements of tire normal forces are used as an input to the method, the tire normal forces that are expected to be present at each tire contact patch may be calculated by using a set of normal force balances such as those shown in equations (27a) through (27d), where N′_{fl}, N′_{fr}, N′ᵣₗ, and N′ᵣᵣ denote expected tire normal forces at the front left, front right, rear left, and rear right tires of a four-wheeled vehicle, aₓ and a_{y} are measured longitudinal and lateral accelerations, and κ_{f} and κᵣ are nominal fractions of the vehicle roll stiffness contributed by the front and rear suspensions, respectively, with the remaining variables and constants used in accord with their earlier descriptions.

$$\begin{matrix}{N}_{fl}^{′} = \frac{{m}_{Tf} g}{2} + {κ}_{f} \frac{{m}_{T} h}{{t}_{w}} {a}_{y} - \frac{{m}_{T} h}{L} {a}_{x} & ( 27 a ) \\ {N}_{fl}^{′} = \frac{{m}_{Tf} g}{2} - {κ}_{f} \frac{{m}_{T} h}{{t}_{w}} {a}_{y} - \frac{{m}_{T} h}{L} {a}_{x} & ( 27 b ) \\ {N}_{fl}^{′} = \frac{{m}_{Tr} g}{2} + {κ}_{f} \frac{{m}_{T} h}{{t}_{w}} {a}_{y} + \frac{{m}_{T} h}{L} {a}_{x} & ( 27 c ) \\ {N}_{fl}^{′} = \frac{{m}_{Tr} g}{2} - {κ}_{f} \frac{{m}_{T} h}{{t}_{w}} {a}_{y} + \frac{{m}_{T} h}{L} {a}_{x} & ( 27 d )\end{matrix}$$

As described earlier, the longitudinal acceleration aₓ may be measured by an accelerometer or calculated by monitoring changes in vehicle speed derived from wheel speed sensors. In the exemplary force balances above, the first group of terms represents a static force contribution due to gravity, while the second group of terms represents a quasi-static force contribution due to side to side load transfer during cornering, and the third group of terms represents a quasi-static force contribution due to fore/aft weight transfer between axles during acceleration/deceleration. The total vehicle mass and mass proportioned between axles are estimated values, whereas the fractions of vehicle roll stiffness, κ_{f} and κᵣ, may be nominal values derived from test data, with κ_{f}+κᵣ=1. In addition, the height of the vehicle center of mass, h, is preferably, but not necessarily, an estimated value rather than a nominal inertial property.

Alternately, when measurements of tire lateral forces are used as an input to the method, the tire lateral forces that are expected to be present may be calculated using force and moment balances, such as those presented previously in equations (20a) and (20b), combined with relationships between vehicle mass and wheelbase, shown previously in equations (21a) and (21b), to produce relationships between tire/axle lateral forces, estimated vehicle mass parameters, and measurements of lateral acceleration, a_{y}, vehicle yaw rate, ω_{z}, and steering angle, δ, from the VSC system, shown in equations (28a) and (28b).

$$\begin{matrix}{F}_{Yf}^{′} = {F}_{Yfl}^{′} + {F}_{Yfr}^{′} = \frac{{m}_{T} {d}_{r} {a}_{y} + {I}_{zz} {ω}_{zder}}{L cos δ} & ( 28 a ) \\ {F}_{Yr}^{′} = {F}_{Yrl}^{′} + {F}_{Yrr}^{′} = \frac{{m}_{T} {d}_{f} {a}_{y} - {I}_{zz} {ω}_{zder}}{L} & ( 28 b )\end{matrix}$$

As indicated earlier, ω_{z} is numerically filtered to approximate its derivative ω_{zder} prior to use. The distances d_{f} and dᵣ are themselves estimated vehicle inertial parameters which incorporate estimated vehicle mass parameters (as shown in the various relations in equations (6), (13), (14), (21a), and (21b)) rather than nominal properties, so that expressions including the estimated masses m_{Tf} and m_{Tr} may be substituted for the distances d_{f} and dᵣ in equations (28a) and (28b). In addition, the vehicle yaw moment of inertia is preferably an estimated value rather than a nominal inertial property.

In the third step, the computing device blends the measured tire forces and the corresponding set of expected tire forces to produce a set of blended tire forces. The different sources of tire force information are blended together using weighting factors, with each weighting factor favoring the measured tire force information immediately after the measurement has been obtained, but changing over time to favor the expected tire force information as the measured tire force becomes ‘stale’. Such blending enables the method to account for differences between the conditions actually observed through low sampling rate measurements of tire forces and the expected conditions calculated in the second step, and to account for changes in conditions that may occur in the intervals between tire force measurements. For example, each weighting factor w may vary according to equation 29, where τ is the time elapsed since the last measurement of tire force was obtained from the tire sensor group in seconds, and the constant 20 has units of s⁻¹.

w=0.9e^{-20τ} (29)

When measurements of tire normal forces are used as an input to the method, the information may be blended using equations such as equations (30a) through (30d), where w₁ through w₄ individually vary based on the time elapsed since a measurement was obtained from the appropriate tire sensor group.

\hat{N}_{fl}=w₁N_{fl}+(1−w₁)N′_{fl} (30a)

\hat{N}_{fr}=w₂N_{fr}+(1−w₂)N′_{fr} (30b)

\hat{N}ᵣₗ=w₃Nᵣₗ+(1−w₃)N′ᵣₗ (30c)

\hat{N}ᵣᵣ=w₄Nᵣᵣ+(1−w₄)N′ᵣᵣ (30d)

The set of blended tire normal forces may serve as a set of predicted tire normal forces for communication to a VSC system or other chassis control system.
Alternately, when measurements of tire lateral forces are used as an input to the method, the information may be blended using equations such as equations (31a) and (31b), where w₁ and w₂ individually vary based on the time elapsed since a measurement was obtained from one of the pertinent tire sensor groups.

\hat{F}_{Yf}=w₁(F_{Yfl}+F_{Yfr})+(1−w₁)(F′_{Yfl}+F′_{Yfr}) (31a)

\hat{F}_{Yr}=w₂(F_{Yrl}+F_{Yrr})+(1−w₂)(F′_{Yrl}+F′_{Yrr}) (31b)

In this embodiment of the method, the expected tire normal forces, calculated according to equations (27a) through (27d) may serve as a set of predicted tire normal forces for communication to a VSC system or other chassis control system.

Optionally, when measurements of tire lateral forces are used as an input to the method, the computing device may calculate offsets between the measured tire lateral forces and the expected tire lateral forces to improve the accuracy and precision of the calculated blended tire forces. During initial operation and data collection, the expected tire lateral forces obtained from equations such as equations (28a) and (28b) may be biased due to discrepancies between the nominal inertial properties likely used to seed the estimated vehicle inertial parameters in the prior discussed methods and the actual inertial properties of the vehicle. Additionally, the expected tire lateral forces may be biased due to the effects of neglected, typically higher order, vehicle dynamics or environmental factors, such as side-impacting wind loads, not accounted for in the prior discussed calculative models. To address such concerns, the computing device may calculate offsets between the measured tire lateral forces and the expected tire lateral forces as a means for improving the accuracy and precision of the blended tire forces. Primary determinations of the offsets per axle, ΔF_{Yf} and ΔF_{Yr}, may be determined by calculating a difference between the expected tire lateral forces and the measured tire lateral forces such as that shown in equations (32a) and (32b).

ΔF_{Yf}=(F′_{Yfl}+F′_{Yfr})−(F_{Yfl}+F_{Yfr}) (32a)

ΔF_{Yr}=(F′_{Yrl}+F′_{Yrr})−(F_{Yrl}+F_{Yrr}) (32b)

Estimated values of the offsets may be determined by limiting the calculated differences to reasonable values, e.g., +2000 N to −2000 N, discarding offsets calculated during quick transient maneuvers, and passing the offsets through a low pass filter. A vehicle may be considered to be in a quick transient maneuver when the magnitude of the time derivative of lateral acceleration, a_{yder}, exceeds a threshold value, or when the time derivative of the vehicle yaw rate, ω_{zder}, exceeds a different threshold value. The low pass filter may, for example, have a transfer function of the form s/(s+a), where s is the Laplace operand and a is a constant parameter, e.g., 10 radians/sec. Such a calculation produces estimated offsets ΔF′_{Yf} and ΔF′_{Yr}, and equations (31a) and (31b) may be altered to incorporate the corrective offsets as shown in equations (33a) and (33b).

\hat{F}_{Yf}=w₁(F_{Yfl}+F_{Yfr})+(1−w₁)(F′_{Yfl}+F′_{Yfr}−ΔF′_{Yf}) (33a)

\hat{F}_{Yr}=w₂(F_{Yrl}+F_{Yrr})+(1−w₂)(F′_{Yrl}+F′_{Yrr}−ΔF′_{Yr}) (33b)

The use of estimated offsets in calculating the predicted set of tire lateral forces will tend to reduce variability between the predicted sets, since a longer data record is required for the estimated vehicle inertial properties developed via the prior discussed methods to reliably estimate the actual vehicle inertial properties. The use of such offsets will also tend to reduce variability between the predicted sets by providing a means for vehicle dynamics or environmental conditions other than those described by the vehicle inertial parameters and VSC system sensor data to be taken into account.

In the fourth step, the computing device combines the set of blended tire forces and a set of expected tire forces of the other kind to produce a set of predicted tire lateral forces for each tire of the vehicle. This step is based upon the observation that for most vehicles on uniform surfaces, tire lateral forces will be distributed between the tires of an axle in approximate proportion to the distribution of the tire normal forces between the tires of the axle. For example, when measurements of tire normal forces are used as an input to the method, the predicted tire lateral forces may be determined using equations (34a) through (34d), where the expected tire lateral forces per axle are calculated using equations such as equations (28a) and (28b) and the normal forces are calculated from equations (30a) through (30d).

$$\begin{matrix}{F}_{Yfl} = \frac{\hat{{N}_{fl}}}{\hat{{N}_{fl}} + \hat{{N}_{fr}}} {F}_{Yf}^{′} & ( 34 a ) \\ {F}_{Yfr} = \frac{\hat{{N}_{fr}}}{\hat{{N}_{fl}} + \hat{{N}_{fr}}} {F}_{Yf}^{′} & ( 34 b ) \\ {F}_{Yrl} = \frac{{\hat{N}}_{rl}}{{\hat{N}}_{rl} + {\hat{N}}_{rr}} {F}_{Yr}^{′} & ( 34 c ) \\ {F}_{Yrr} = \frac{{\hat{N}}_{rr}}{{\hat{N}}_{rl} + {\hat{N}}_{rr}} {F}_{Yr}^{′} & ( 34 d )\end{matrix}$$

Alternately, when measurements of tire lateral forces are used as an input to the method, the predicted tire lateral forces may be determined using equations (35a) through (35d), where the expected tire normal forces are calculated using equations such as equations (27a) through (27d) and the lateral forces per axle are calculated using equations such as equations (31a) and (31b) or (33a) and (33b).

$$\begin{matrix}{\begin{matrix}{F}_{Yfl} = \frac{{N}_{fl}^{′}}{{N}_{fl}^{′} + {N}_{fr}^{′}} {\hat{F}}_{Yf} & ( 35 a )\end{matrix}}_{□} & ( 35 a ) \\ {F}_{Yfr} = \frac{{N}_{fr}^{′}}{{N}_{fl}^{′} + {N}_{fr}^{′}} {\hat{F}}_{Yf} & ( 35 b ) \\ {F}_{Yrl} = \frac{{N}_{rl}^{′}}{{N}_{rl}^{′} + {N}_{rr}^{′}} {\hat{F}}_{Yr} & ( 35 c ) \\ {F}_{Yrr} = \frac{{N}_{rr}^{′}}{{N}_{rl}^{′} + {N}_{rr}^{′}} {\hat{F}}_{Yr} & ( 35 d )\end{matrix}$$

Thus the set of blended tire normal forces can be used to resolve a set of expected tire/axle lateral forces into individual predictions of tire lateral force for use in the VSC system. Similarly, a set of blended tire lateral forces can be resolved into individual predictions of tire lateral force, rather than summed tire lateral forces, by approximating the actual tire normal forces with a set of expected values.

In the fifth step, the computing device may, if the control system itself, perform a calculation using the predicted tire normal and lateral forces or, if an accessory computing device in communication with a control system, transmit the predicted tire normal and lateral forces to the system for use in a vehicle stability control calculation. As described earlier, the control system may be a VSC system or another chassis control system such as a traction control system or active suspension system.

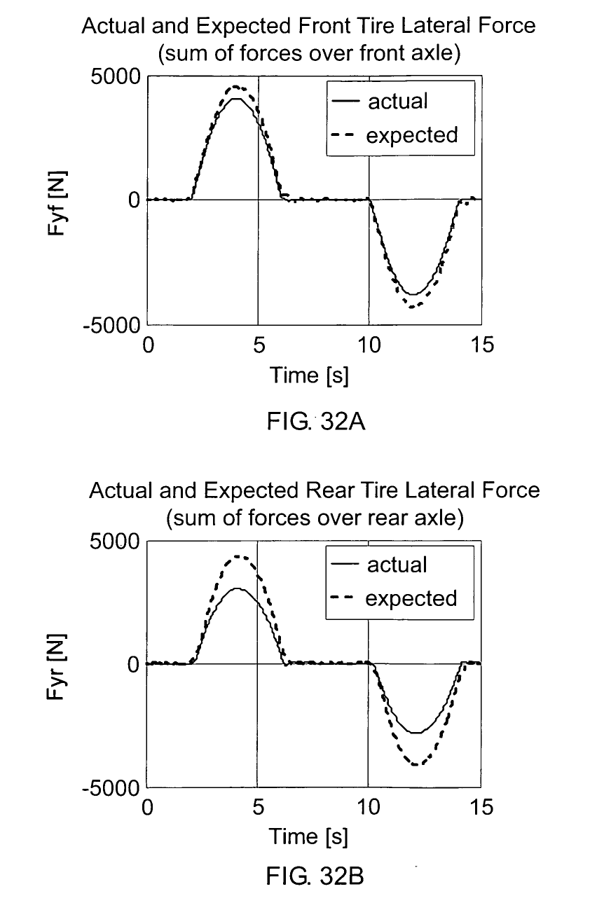

Further results from simulations performed using the CARSIM® vehicle simulation environment, as described above, are provided in order to illustrate the significance of the disclosed method. In the initial two-turn scenario described in paragraph 0051 above, calculations of the expected tire lateral forces were performed using equations (28a) and (28b), but employing only the initial, nominal property values shown in Table 1, rather than evolving estimates of the vehicle inertial properties during the simulated interval. The expected tire lateral forces were subsequently plotted for comparison with the actual tire lateral forces, as indicated by the simulation environment, which additionally provide a reasonable indication of the forces that would be measured by intelligent tire sensors. As shown in FIGS. 32A and 32B, the expected tire lateral forces based only on nominal inertial properties were consistently larger than the actual tire lateral forces during periods of interest, i.e., during execution of the turning maneuvers, due to discrepancies between the nominal and actual vehicle loads. It should be noted that FIGS. 32A-38B combine the relevant data into lateral forces per axle for sake of brevity and simplicity, but that predicted tire lateral forces are produced for each vehicle tire in the disclosed method. It should also be noted that FIGS. 32A-38B plot the expected or predicted tire lateral forces as a dotted line to distinguish the data from the actual tire lateral forces, and that these figures do not illustrate the entirety of the high sampling rate predictions obtainable via the disclosed methods.

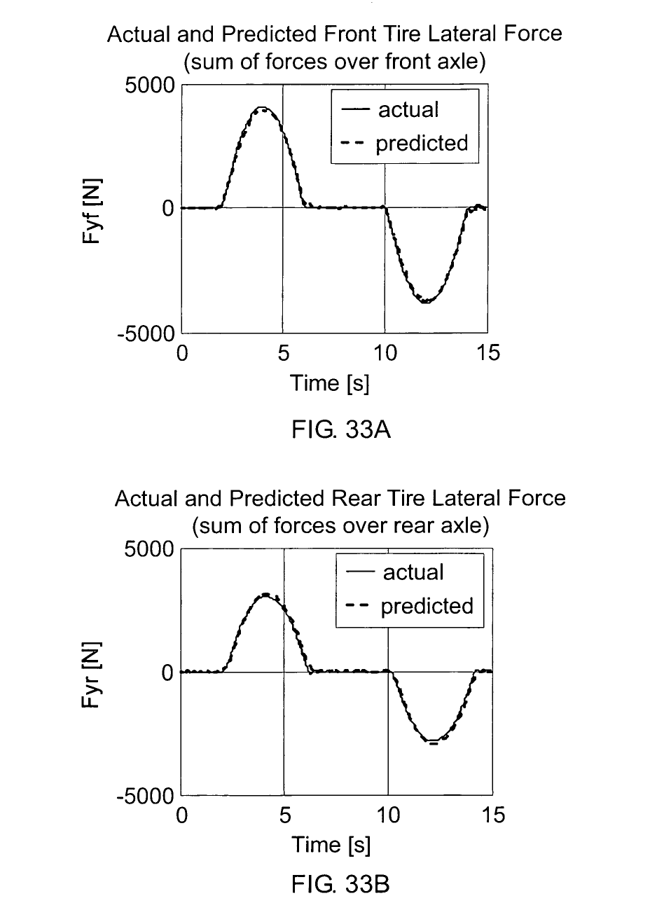

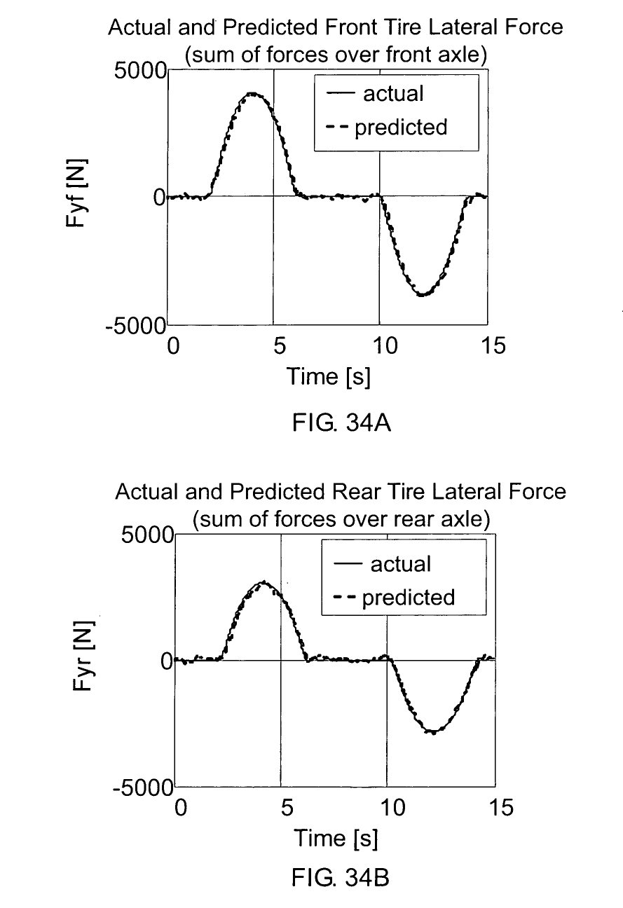

The initial two-turn scenario was subsequently rerun, but using the method of estimating vehicle inertial parameters discussed in paragraph 0039 above, and the method of predicting tire lateral forces described herein. Specifically, measurements of tire normal forces were obtained from the intelligent tire sensors at low sampling rates, calculation of the set of expected tire normal forces was performed using equations (27a) through (27d), calculation of the set of blended tire normal forces was performed using equations (29) and (30a) through (30d), calculation of the set of expected tire lateral forces was performed using equations (28a) and (28b), and calculation of the set of predicted tire lateral forces was performed using equations (34a) through (34d). FIGS. 33A and 33B plot the predicted tire lateral forces versus actual tire lateral forces over the simulated interval. Similarly, the initial two-turn scenario was rerun again, but using the method of estimating vehicle inertial parameters discussed in paragraph 0058 above in combination with the method of predicting tire lateral forces described herein. Specifically, measurements of tire lateral forces were obtained from the intelligent tire sensors at low sampling rates, calculation of the set of expected tire lateral forces was performed using equations (28a) and (28b), calculation of the set of blended tire lateral forces was performed using equations (29), (33a), and (33b) in combination with the described calculation of offsets, calculation of the set of expected tire normal forces was performed using equations (27a) through (27d), and calculation of the set of predicted tire lateral forces was performed using equations (35a) through (35d). FIGS. 34A and 34B plot the predicted tire lateral forces versus actual tire lateral forces over the simulated interval. In these exemplary implementations, which combine the previously described methods for estimating vehicle inertial parameters with the presently described method for predicting tire lateral forces, the predicted tire lateral forces match the actual values quite closely after a comparatively short period of initial operation and data collection.

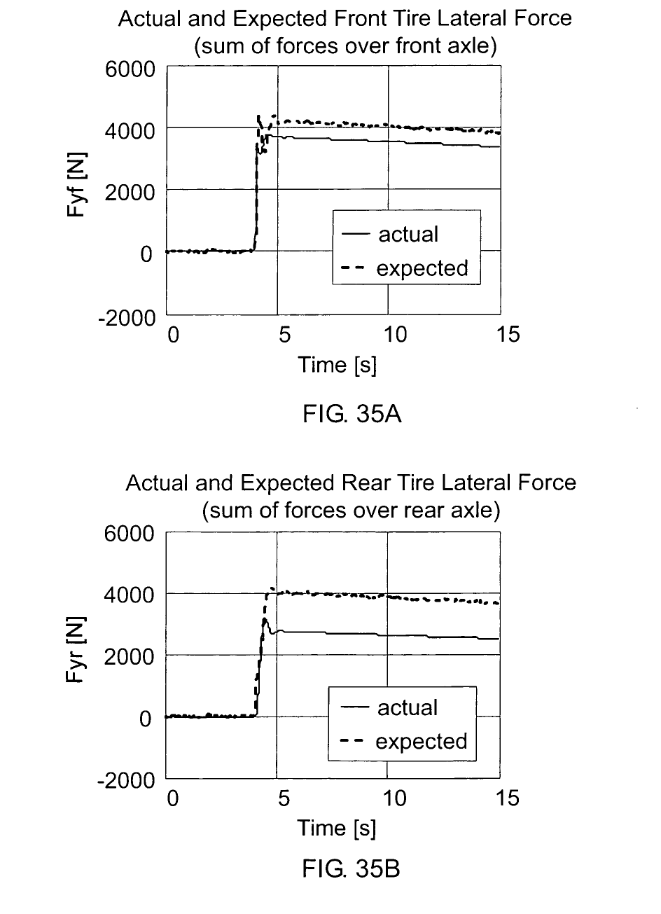

For further illustration, results from the second ‘step steer’ scenario are also provided. During simulation of the ‘step steer’ maneuver, as described in paragraph 0052 above, calculations of the expected tire lateral forces were again performed using equations (28a) and (28b) and plotted for comparison with the actual tire lateral forces indicated by the simulation environment. As shown in FIGS. 35A and 35B, which combine the relevant data into lateral forces per axle for sake of simplicity, the expected tire lateral forces based only on nominal inertial properties were again generally larger than the actual lateral forces during periods of interest, i.e., during execution of the turning maneuver, due to discrepancies between the nominal and actual vehicle loads.

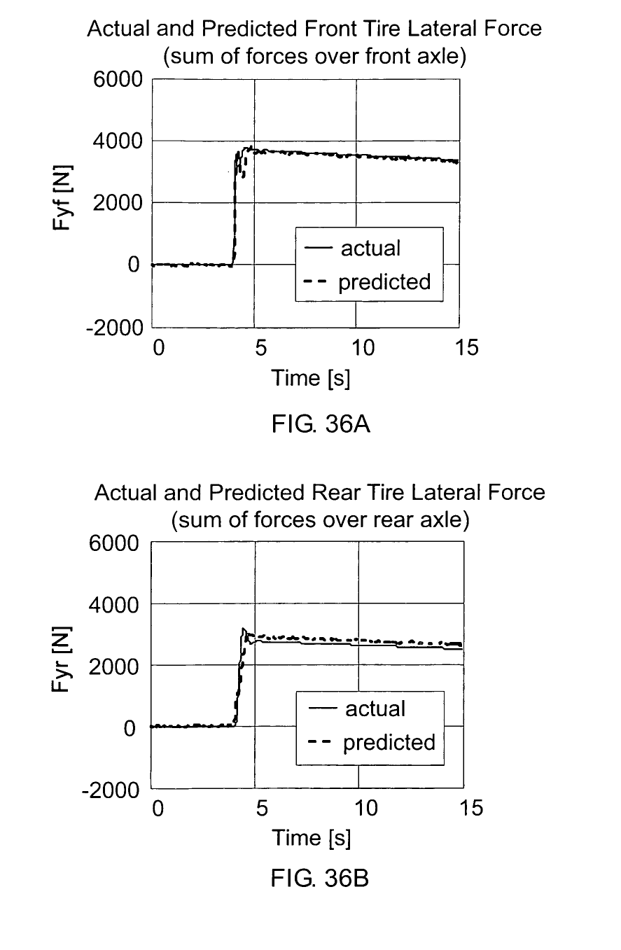

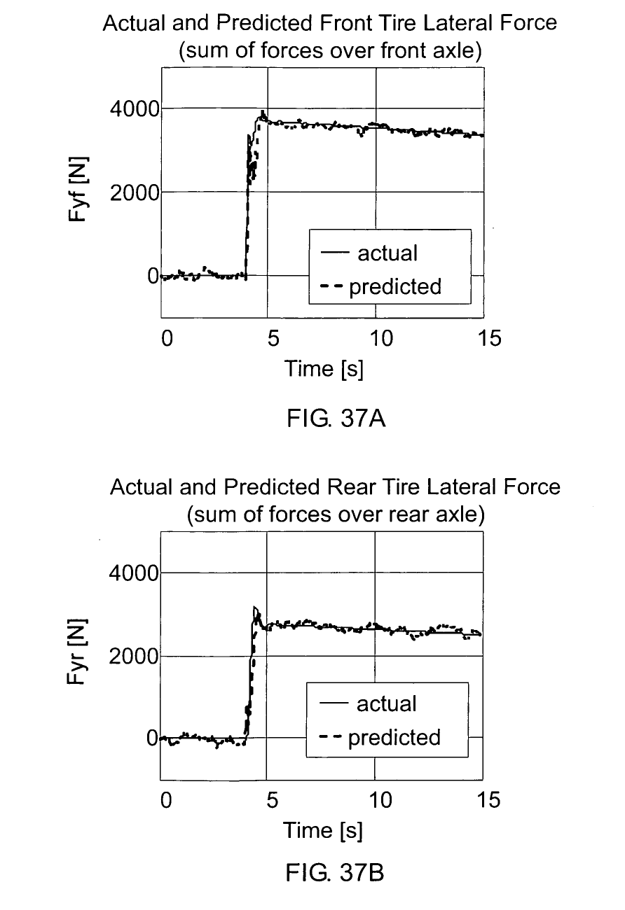

The ‘step steer’ scenario was then rerun, but using the method of estimating vehicle inertial parameters discussed in paragraph 0039 above in combination with the method of predicting tire lateral forces, the latter being implemented in the same manner used in the comparable two-turn scenario. FIGS. 36A and 36B plot the predicted tire lateral forces versus actual tire lateral forces over the simulated interval. Similarly, the ‘step steer’ scenario was rerun again, but using the method of estimating vehicle inertial parameters discussed in paragraph 0058 above in combination with the method of predicting tire lateral forces, the latter being implemented in the same manner used in the comparable two-turn scenario. FIGS. 37A and 37B plot the predicted tire lateral forces versus actual tire lateral forces over the simulated interval. In these exemplary implementations, the predicted tire lateral forces again match the actual values quite closely after a comparatively short period of initial operation and data collection.

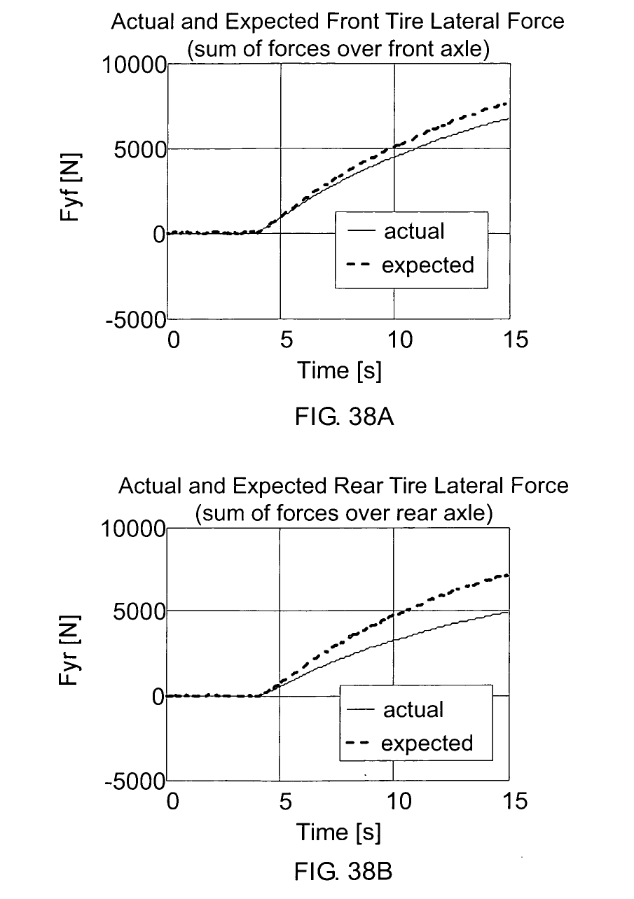

For yet further illustration, results from the third ‘ramp steer’ scenario are also provided. During simulation of the ‘ramp steer’ maneuver, as described in paragraph 0053 above, calculations of the expected tire lateral forces were again performed using equations (28a) and (28b) and plotted for comparison with the actual tire lateral forces indicated by the simulation environment. As shown in FIGS. 38A and 38B, which combine the relevant data into lateral forces per axle for sake of simplicity, the expected tire lateral forces based only on nominal inertial properties were again generally larger than the actual lateral forces during periods of interest, i.e., during execution of the turning maneuver, due to discrepancies between the nominal and actual vehicle loads.

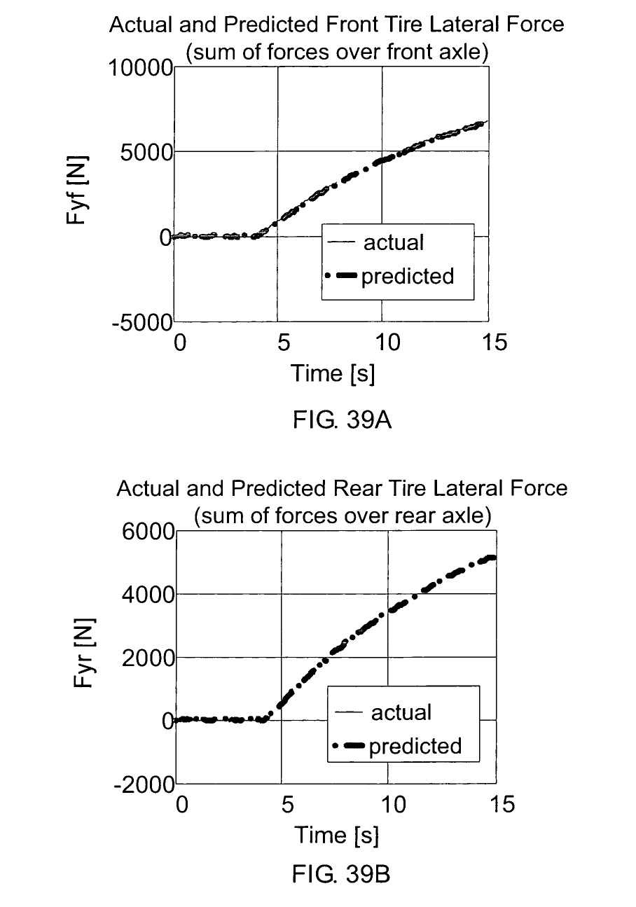

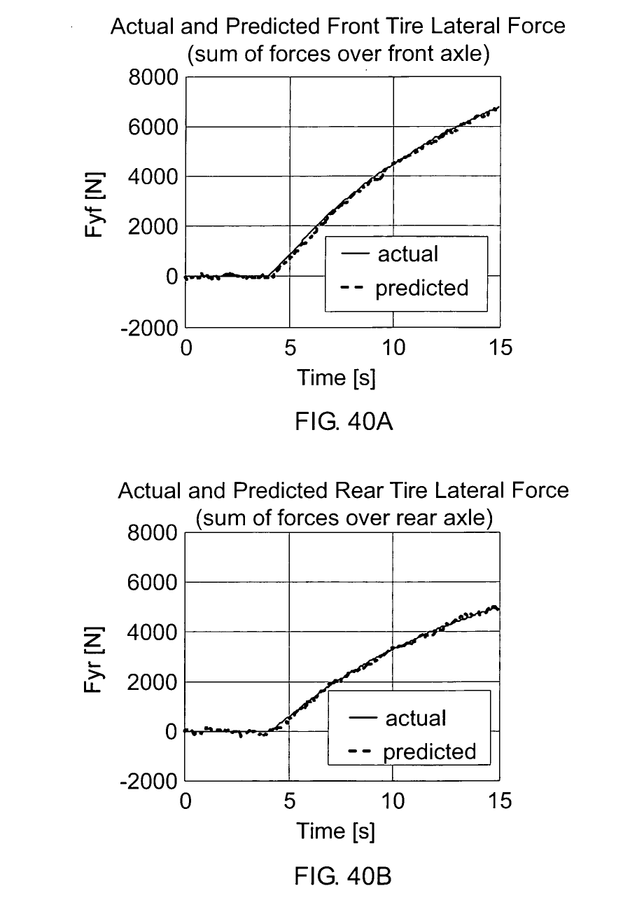

The ‘ramp steer’ scenario was then rerun, but using the method of estimating vehicle inertial parameters discussed in paragraph 0039 above in combination with the method of predicting tire lateral forces, the latter being implemented in the same manner used in the comparable two-turn scenario. FIGS. 39A and 39B plot the predicted tire lateral forces versus actual tire lateral forces over the simulated interval. Similarly, the ‘ramp steer’ scenario was rerun again, but using the method of estimating vehicle inertial parameters discussed in paragraph 0058 above in combination with the method of predicting tire lateral forces, the latter being implemented in the same manner used in the comparable two-turn scenario. FIGS. 40A and 40B plot the predicted tire lateral forces versus actual tire lateral forces over the simulated interval. In these exemplary implementations, the predicted tire lateral forces again match the actual values quite closely after a comparatively short period of initial operation and data collection.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of applicants' general inventive concept.

What is claimed is:

1. A method of estimating vehicle inertial parameters for use in a vehicle stability control system, the method comprising the steps of:
obtaining measurements of tire normal forces;
calculating an estimated total vehicle mass;
calculating an estimated mass proportioned between axles, comprising an estimated front mass and an estimated rear mass; and
performing a vehicle stability control calculation using an estimated vehicle inertial parameter selected from a group consisting of said estimated total vehicle mass, said estimated mass proportioned between axles, said estimated front mass, and said estimated rear mass.

2. The method of claim 1, further comprising the steps of:
calculating an estimated vehicle yaw moment of inertia; and
performing a vehicle stability control calculation using said estimated vehicle yaw moment of inertia.

3. The method of claim 1, further comprising the steps of:
obtaining a measurement of lateral acceleration during quasi-steady state cornering;
calculating an estimated height of the vehicle center of mass; and
performing a vehicle stability control calculation using said estimated height of the vehicle center of mass.

4. The method of claim 3, further comprising the steps of:
calculating an estimated vehicle static stability factor, and
performing a vehicle stability control calculation using said estimated vehicle static stability factor.

5. The method of claim 1, further comprising the step of:
calculating a non-gravitational contribution to said measured tire normal forces.

6. The method of claim 5, wherein the step of calculating a non-gravitational contribution comprises the calculation of an aerodynamic force contribution to the measured tire normal forces.

7. The method of claim 1, wherein at least one of the estimated total vehicle mass, estimated mass proportioned between axles estimated front mass, and estimated rear mass is calculated using a recursive averaging algorithm.

8. The method of claim 7, wherein said recursive averaging algorithm is selectively weighted with a weight factor, said weight factor being varied according to a predetermined rule in response to the longitudinal acceleration of the vehicle.

9. A method of estimating vehicle inertial parameters for use in a vehicle stability control system, the method comprising the steps of:
obtaining measurements of tire lateral forces, vehicle lateral acceleration, and vehicle yaw rate;
calculating an estimated mass proportioned between axles, comprising an estimated front mass and an estimated rear mass; and
performing a vehicle stability control calculation using an estimated vehicle inertial parameter selected from a group consisting of said estimated mass proportioned between axles, said estimated front mass, and said estimated rear mass, or a vehicle parameter incorporating an estimated vehicle inertial parameter selected from said group.

10. The method of claim 9, further comprising the steps of:
calculating an estimated vehicle yaw moment of inertia; and
performing a vehicle stability control calculation using said estimated vehicle yaw moment of inertia.

11. The method of claim 9, wherein at least one of the estimated mass proportioned between axles, estimated front mass, and estimated rear mass is calculated using a recursive averaging algorithm.

12. The method of claim 11, wherein said recursive averaging algorithm is selectively weighted with a weight factor, said weight factor being varied according to a predetermined rule in response to the longitudinal acceleration of the vehicle.

13. The method of claim 9, wherein the calculation step is based upon a bicycle model of vehicle dynamics, and wherein the modeled vehicle has only a front axle and a rear axle.

14. A method of predicting tire lateral forces for use in a vehicle chassis control system, the method comprising the steps of:
obtaining measurements of tire forces, the measured forces being selected from one of group consisting of tire normal forces and tire lateral forces;
calculating a first set of expected tire forces, corresponding to the selected one of the aforesaid group, using an estimated vehicle inertial parameter and a measurement of acceleration;
blending said measured tire forces and said first set of expected tire forces to produce a set of blended tire forces;
calculating a second set of expected tire forces, corresponding to the other of the aforesaid group, using an estimated vehicle mass parameter and a measurement of acceleration;
combining said set of blended tire forces and said second set of expected tire forces to produce a set of predicted tire lateral forces for each tire of the vehicle; and
performing a vehicle control calculation using said set of predicted tire lateral forces.

15. The method of claim 14, wherein at least one of said first set of expected tire forces and said second set of expected tire forces is calculated using an estimated height of the vehicle center of mass.

16. The method of claim 14, wherein at least one of said first set of expected tire forces and said second set of expected tire forces is calculated using an estimated vehicle yaw moment of inertia.

17. The method of claim 14, wherein said blended tire forces are calculated using estimated offsets between said measured tire forces and said first set of expected tire forces.

18. The method of claim 14, wherein the calculations of tire lateral forces are based upon a bicycle model of vehicle dynamics, and wherein the modeled vehicle has only a front axle and a rear axle.

19. The method of claim 14, wherein the step of blending said measured tire forces favors measured tire force information immediately after a measurement has been obtained, but changes to favor expected tire force information over time.

20. The method of claim 14, wherein the measured forces are tire normal forces, and further comprising the step of:
performing a vehicle control calculation using said set of blended tire normal forces.
